(19) United States
(12) Patent Application Publication
(10) Pub. No.: US 2025/0173089 A1
(43) Pub. Date: May 29, 2025

(54) CROSS-DOMAIN SOLUTION FABRIC

(71) Applicant: Intel Corporation, Santa Clara, CA (US)

(72) Inventors: Akhilesh Thyagaturu, Ruskin, FL (US); Jason Howard, Portland, OR (US); Gurpreet Singh Kalsi, Portland, OR (US); Hrvoje Vrsalovic, Sunnyvale, CA (US); Sanjaya Tayal, Portland, OR (US)

(73) Assignee: Intel Corporation, Santa Clara, CA (US)

(21) Appl. No.: 19/003,180

(22) Filed: Dec. 27, 2024

(51) Int. Cl. G06F 3/06

(52) U.S. Cl. CPC G06F 3/0655; G06F 3/061; G06F 3/0679

(57) ABSTRACT

A network processing device implements a cross-domain solution (CDS) and includes a shared memory, an I/O interface, a network interface, and a CDS manager to create a buffer in the shared memory to allow writes by a first software module in a first domain and reads by a second software module in a second domain, where the reads are received from the second software module over a network connection facilitated by the network interface. The buffer is used to implement a memory-based communication channel between the first software module and the second software module, where the first domain is independent of the second domain.

### BACKGROUND

A data center may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

Edge computing, including mobile edge computing, may offer application developers and content providers cloud-computing capabilities and an information technology service environment at the edge of a network. Edge computing may have some advantages when compared to traditional centralized cloud computing environments. For example, edge computing may provide a service to a user equipment (UE) with a lower latency, a lower cost, a higher bandwidth, a closer proximity, or an exposure to real-time radio network and context information.

### BRIEF DESCRIPTION OF THE FIGURES

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a simplified block diagram illustrating example components of a data center.

FIG. 2 is a simplified block diagram illustrating an example computing system.

FIG. 3 is an example approach for networking and services in an edge computing system.

FIG. 4 is a simplified block diagram illustrating an example computing device.

FIG. 5 is a simplified block diagram illustrating an example computing system.

FIG. 6 is a simplified block diagram illustrating an example cross-domain solution (CDS).

FIG. 7 is a simplified block diagram illustrating an example memory-based CDS (M-CDS) implementation.

FIG. 8 is a simplified block diagram illustrating example deployment of M-CDS devices to couple different computing domains.

FIG. 9 is a simplified block diagram illustrating an example M-CDS device.

FIG. 10 is a simplified block diagram illustrating example M-CDS management logic.

FIG. 11 is a simplified block diagram illustrating example components of an example M-CDS device.

FIG. 12 is a simplified block diagram illustrating the coupling of clients in two computing domains through an example M-CDS device.

FIG. 13 is a simplified flow diagram illustrating the example creation and use of memory-based communication channels using an example M-CDS device.

FIG. 14 is a simplified block diagram illustrating an example system including a network of M-CDS devices.

FIG. 15 is a simplified block diagram illustrating an example system including a network of M-CDS devices coupled to host devices.

FIG. 16 is a simplified block diagram illustrating network processing devices coupled together by a backplane.

FIG. 17 is a simplified block diagram illustrating backplanes coupling example network processing devices.

FIG. 18 is a simplified flow diagram illustrating an example fabric implemented through a network of interconnected network processing devices.

FIG. 19 is a simplified block diagram illustrating an example implementation of an application utilizing a network of interconnected network processing devices.

FIG. 20 is a simplified block diagram illustrating example network processing devices.

FIG. 21 is a simplified block diagram illustrating an example memory transfer in a network of interconnected network processing devices.

FIG. 22 illustrates a block diagram of an example processor device in accordance with certain embodiments.

Like reference numbers and designations in the various drawings indicate like elements.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

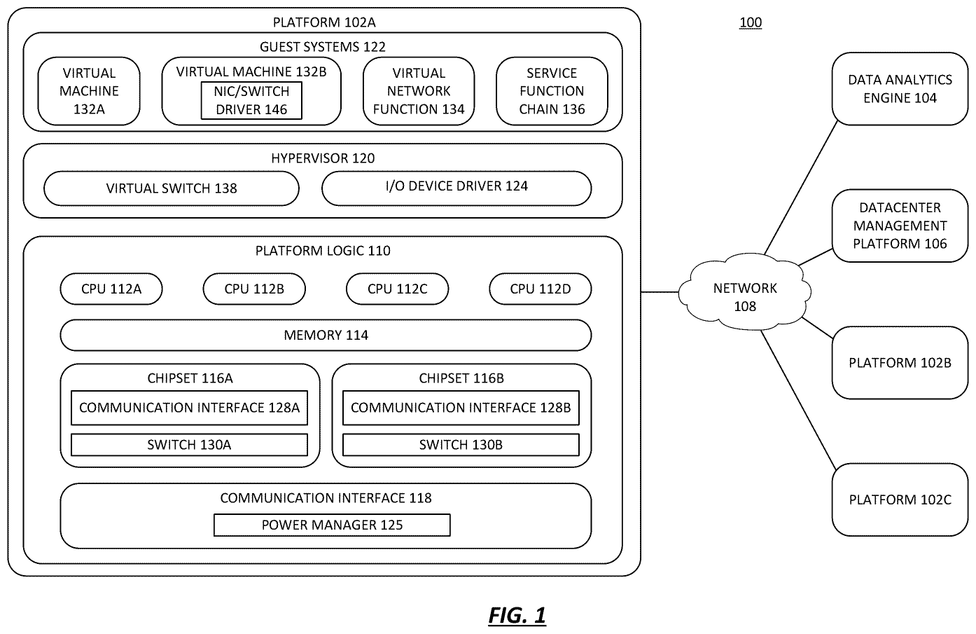

FIG. 1 illustrates a block diagram of components of a datacenter 100 in accordance with certain embodiments. In the embodiment depicted, datacenter 100 includes a plurality of platforms (e.g., 102B-102C), data analytics engine 104, and datacenter management platform 106 coupled together through network 108. In some implementations, the connection between a platform (e.g., 102) and other platforms, engines, and devices may be facilitated through a memory-based communication channel, such as implemented through a memory-based cross-domain solution (M-CDS) device, such as discussed herein. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators and the use of Compute Express Link (CXL) memory semantics to make such cluster more efficient, among other example enhancements.

Each platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, composable servers, disaggregated servers, or other suitable structures that comprises multiple platforms coupled together through network 108 (which may comprise, e.g., a rack or backplane switch).

CPUs 112 may each comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. Although four CPUs are shown, a platform 102 may include any suitable number of CPUs.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may each comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. Each chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on each CPU.

Chipsets 116 may each include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, NVLink, Ultra Path Interconnect (UPI), Universal Chiplet Interconnect Express (UCIe), and others, which may each alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. Each platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

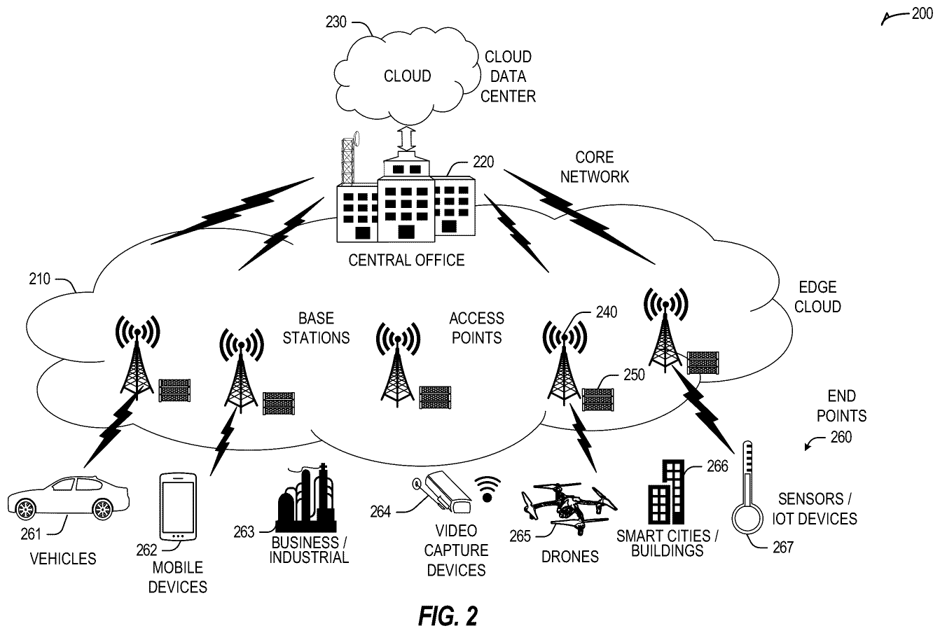

A data center, such as introduced above, may be utilized in connection with a cloud, edge, machine-to-machine, or IoT system. Indeed, principles of the solutions discussed herein may be employed in datacenter systems (e.g., server platforms) and/or devices utilized to implement a cloud, edge, or IoT environment, among other example computing environments. For instance, FIG. 2 is a block diagram 200 showing an overview of a configuration for edge computing, which includes a layer of processing referred to in many of the following examples as an “edge cloud” or “edge system”. As shown, the edge cloud 210 is co-located at an edge location, such as an access point or base station 240, a local processing hub 250, or a central office 220, and thus may include multiple entities, devices, and equipment instances. The edge cloud 210 is located much closer to the endpoint (consumer and producer) data sources 260 (e.g., autonomous vehicles 261, user equipment 262, business and industrial equipment 263, video capture devices 264, drones 265, smart cities and building devices 266, sensors and IoT devices 267, etc.) than the cloud data center 230. Compute, memory, and storage resources which are offered at the edges in the edge cloud 210 may be leveraged to provide ultra-low latency response times for services and functions used by the endpoint data sources 260 as well as reduce network backhaul traffic from the edge cloud 210 toward cloud data center 230 thus improving energy consumption and overall network usages among other benefits.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 210.

As such, an edge cloud 210 may be formed from network components and functional features operated by and within edge gateway nodes, edge aggregation nodes, or other edge compute nodes among network layers. An edge cloud 210 may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 210 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks. Further, connections between nodes and services may be implemented, in some cases, using M-CDS devices, such as discussed herein.

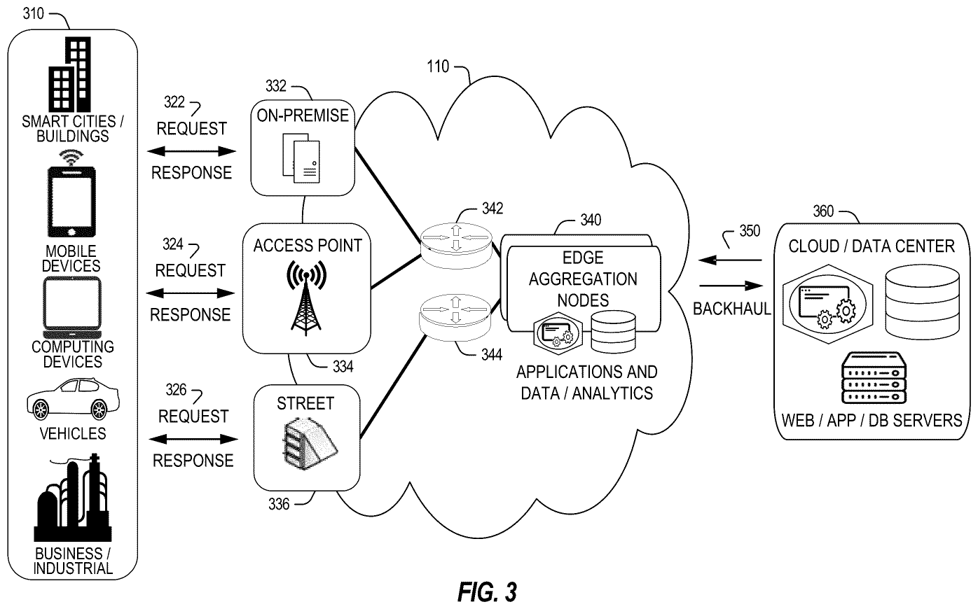

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 210 to aggregate traffic and requests. Thus, within the edge cloud 210, the TSP may deploy various compute and storage resources, such as at edge aggregation nodes 340, to provide requested content. The edge aggregation nodes 340 and other systems of the edge cloud 210 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 210 or other areas of the TSP infrastructure.

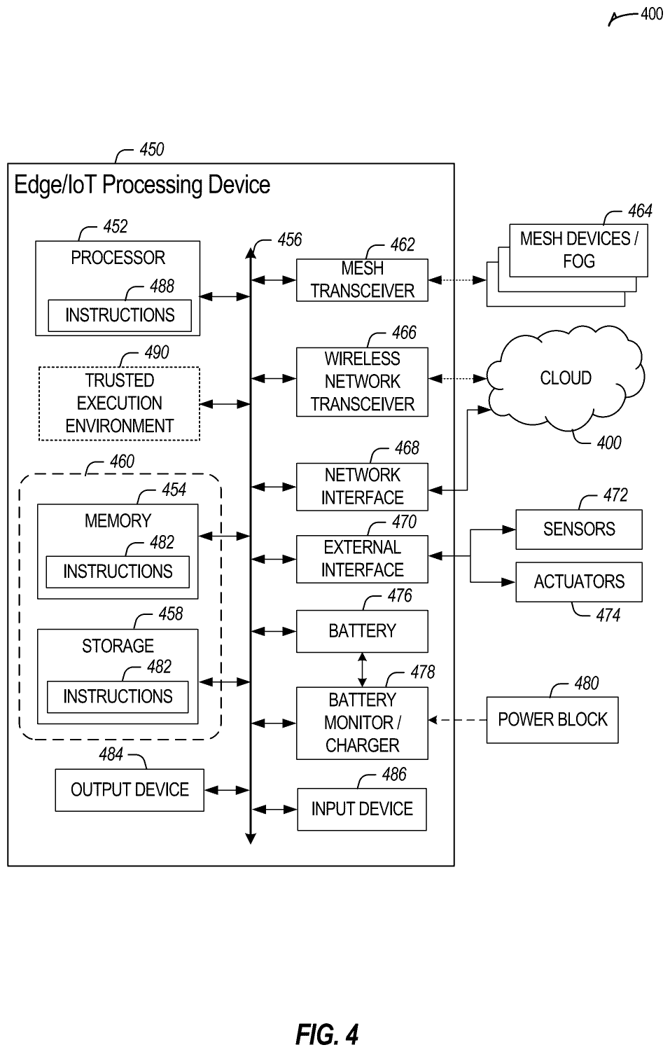

FIG. 4 is a block diagram of an example of components that may be present in an example edge computing device 450 for implementing the techniques described herein. The edge device 450 may include any combinations of the components shown in the example or referenced in the disclosure above. The components may be implemented as ICs, intellectual property blocks, portions thereof, discrete electronic devices, or other modules, logic, hardware, software, firmware, or a combination thereof adapted in the edge device 450, or as components otherwise incorporated within a chassis of a larger system. Additionally, the block diagram of FIG. 4 is intended to depict a high-level view of components of the edge device 450. However, some of the components shown may be omitted, additional components may be present, and different arrangements of the components shown may occur in other implementations.

The edge device 450 may include processor circuitry in the form of, for example, a processor 452, which may be a microprocessor, a multi-core processor, a multithreaded processor, an ultra-low voltage processor, an embedded processor, or other known processing elements. The processor 452 may be a part of a system on a chip (SoC) in which the processor 452 and other components are formed into a single integrated circuit, or a single package. The processor 452 may communicate with a system memory 454 over an interconnect 456 (e.g., a bus). Any number of memory devices may be used to provide for a given amount of system memory. To provide for persistent storage of information such as data, applications, operating systems and so forth, a storage 458 may also couple to the processor 452 via the interconnect 456. In an example the storage 458 may be implemented via a solid state disk drive (SSDD). Other devices that may be used for the storage 458 include flash memory cards, such as SD cards, microSD cards, XD picture cards, and the like, and USB flash drives. In low power implementations, the storage 458 may be on-die memory or registers associated with the processor 452. However, in some examples, the storage 458 may be implemented using a micro hard disk drive (HDD). Further, any number of new technologies may be used for the storage 458 in addition to, or instead of, the technologies described, such resistance change memories, phase change memories, holographic memories, or chemical memories, among others.

The components may communicate over the interconnect 456. The interconnect 456 may include any number of technologies, including PCI express (PCIe), Compute Express Link (CXL), NVLink, HyperTransport, or any number of other technologies. The interconnect 456 may be a proprietary bus, for example, used in a SoC based system. Other bus systems may be included, such as an 12C interface, an SPI interface, point to point interfaces, and a power bus, among others. In some implementations, the communication may be facilitated through an M-CDS device, such as discussed herein. Indeed, in some implementations, communications according to a conventional interconnect protocol (e.g., PCIe, CXL, Ethernet, etc.) may be emulated via messages exchanged over the M-CDS, among other example implementations.

Given the variety of types of applicable communications from the device to another component or network, applicable communications circuitry used by the device may include or be embodied by any one or more of components 462, 466, 468, or 470. Accordingly, in various examples, applicable means for communicating (e.g., receiving, transmitting, etc.) may be embodied by such communications circuitry. For instance, the interconnect 456 may couple the processor 452 to a mesh transceiver 462, for communications with other mesh devices 464. The mesh transceiver 462 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. The mesh transceiver 462 may communicate using multiple standards or radios for communications at different ranges. Further, such communications may be additionally emulated or involve message transfers using an M-CDS device, such as discussed herein, among other examples.

A wireless network transceiver 466 may be included to communicate with devices or services in the cloud 400 via local or wide area network protocols. For instance, the edge device 450 may communicate over a wide area using LoRaWAN™ (Long Range Wide Area Network), among other example technologies. Indeed, any number of other radio communications and protocols may be used in addition to the systems mentioned for the mesh transceiver 462 and wireless network transceiver 466, as described herein. For example, the radio transceivers 462 and 466 may include an LTE or other cellular transceiver that uses spread spectrum (SPA/SAS) communications for implementing high speed communications. Further, any number of other protocols may be used, such as Wi-Fi® networks for medium speed communications and provision of network communications. A network interface controller (NIC) 468 may be included to provide a wired communication to the cloud 400 or to other devices, such as the mesh devices 464. The wired communication may provide an Ethernet connection, or may be based on other types of networks, protocols, and technologies. In some instances, one or more host devices may be communicatively coupled to an M-CDS device via one or more such wireless network communication channels.

The interconnect 456 may couple the processor 452 to an external interface 470 that is used to connect external devices or subsystems. The external devices may include sensors 472, such as accelerometers, level sensors, flow sensors, optical light sensors, camera sensors, temperature sensors, a global positioning system (GPS) sensors, pressure sensors, barometric pressure sensors, and the like. The external interface 470 further may be used to connect the edge device 450 to actuators 474, such as power switches, valve actuators, an audible sound generator, a visual warning device, and the like. External devices may include M-CDS devices and other external devices may be coupled to through an M-CDS, among other example implementations.

The storage 458 may include instructions 482 in the form of software, firmware, or hardware commands to implement the workflows, services, microservices, or applications to be carried out in transactions of an edge system, including techniques described herein. Although such instructions 482 are shown as code blocks included in the memory 454 and the storage 458, it may be understood that any of the code blocks may be replaced with hardwired circuits, for example, built into an application specific integrated circuit (ASIC). In some implementations, hardware of the edge computing device 450 (separately, or in combination with the instructions 488) may configure execution or operation of a trusted execution environment (TEE) 490. In an example, the TEE 490 operates as a protected area accessible to the processor 452 for secure execution of instructions and secure access to data, among other example features.

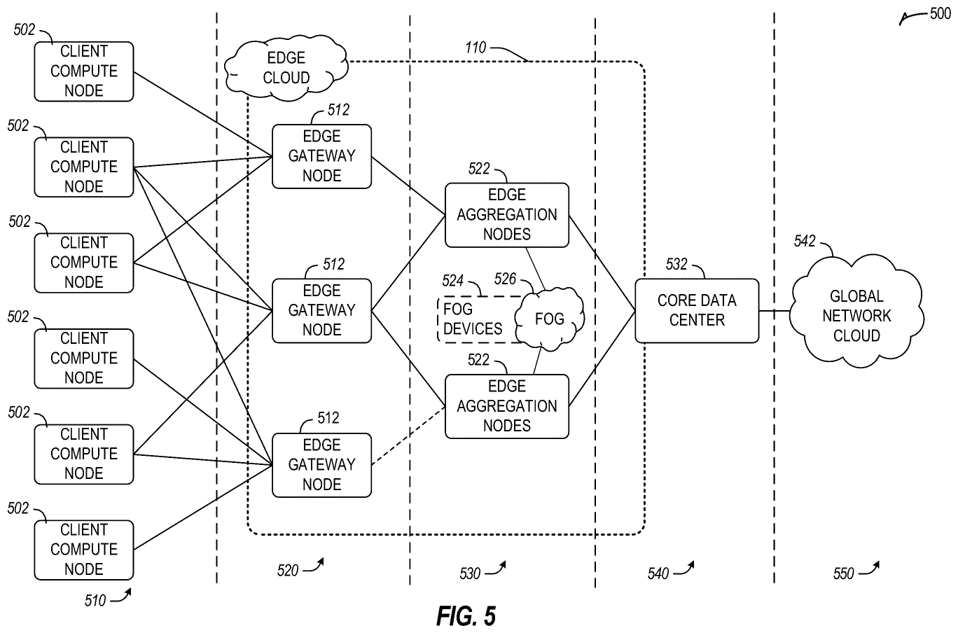

FIG. 5 provides a further abstracted overview of layers of distributed compute, including a data center or cloud and edge computing devices. For instance, FIG. 5 generically depicts an edge computing system for providing edge services and applications to multi-stakeholder entities, as distributed among one or more client compute nodes 502, one or more edge gateway nodes 512, one or more edge aggregation nodes 522, one or more core data centers 532, and a global network cloud 542, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

Each node or device of the edge computing system is located at a particular layer corresponding to layers 510, 520, 530, 540, 550. For example, the client compute nodes 502 are each located at an endpoint layer 510, while each of the edge gateway nodes 512 are located at an edge devices layer 520 (local level) of the edge computing system. Additionally, each of the edge aggregation nodes 522 (and/or fog devices 524, if arranged or operated with or among a fog networking configuration 526) are located at a network access layer 530 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 532 is located at a core network layer 540 (e.g., a regional or geographically-central level), while the global network cloud 542 is located at a cloud data center layer 550 (e.g., a national or global layer). The use of “core” is provided as a term for a centralized network location-deeper in the network-which is accessible by multiple edge nodes or components; however, a “core” does not necessarily designate the “center” or the deepest location of the network. Accordingly, the core data center 532 may be located within, at, or near the edge cloud 210.

Although an illustrative number of client compute nodes 502, edge gateway nodes 512, edge aggregation nodes 522, core data centers 532, global network clouds 542 are shown in FIG. 5, it should be appreciated that the edge computing system may include more or fewer devices or systems at each layer. Additionally, as shown in FIG. 5, the number of components of each layer 510, 520, 530, 540, 550 generally increases at each lower level (i.e., when moving closer to endpoints). As such, one edge gateway node 512 may service multiple client compute nodes 502, and one edge aggregation node 522 may service multiple edge gateway nodes 512.

In some examples, the edge cloud 210 may form a portion of or otherwise provide an ingress point into or across a fog networking configuration 526 (e.g., a network of fog devices 524, not shown in detail), which may be embodied as a system-level horizontal and distributed architecture that distributes resources and services to perform a specific function. For instance, a coordinated and distributed network of fog devices 524 may perform computing, storage, control, or networking aspects in the context of an IoT system arrangement. Other networked, aggregated, and distributed functions may exist in the edge cloud 210 between the cloud data center layer 550 and the client endpoints (e.g., client compute nodes 502).

The edge gateway nodes 512 and the edge aggregation nodes 522 cooperate to provide various edge services and security to the client compute nodes 502. Furthermore, because each client compute node 502 may be stationary or mobile, each edge gateway node 512 may cooperate with other edge gateway devices to propagate presently provided edge services and security as the corresponding client compute node 502 moves about a region. To do so, each of the edge gateway nodes 512 and/or edge aggregation nodes 522 may support multiple tenancy and multiple stakeholder configurations, in which services from (or hosted for) multiple service providers and multiple consumers may be supported and coordinated across a single or multiple compute devices.

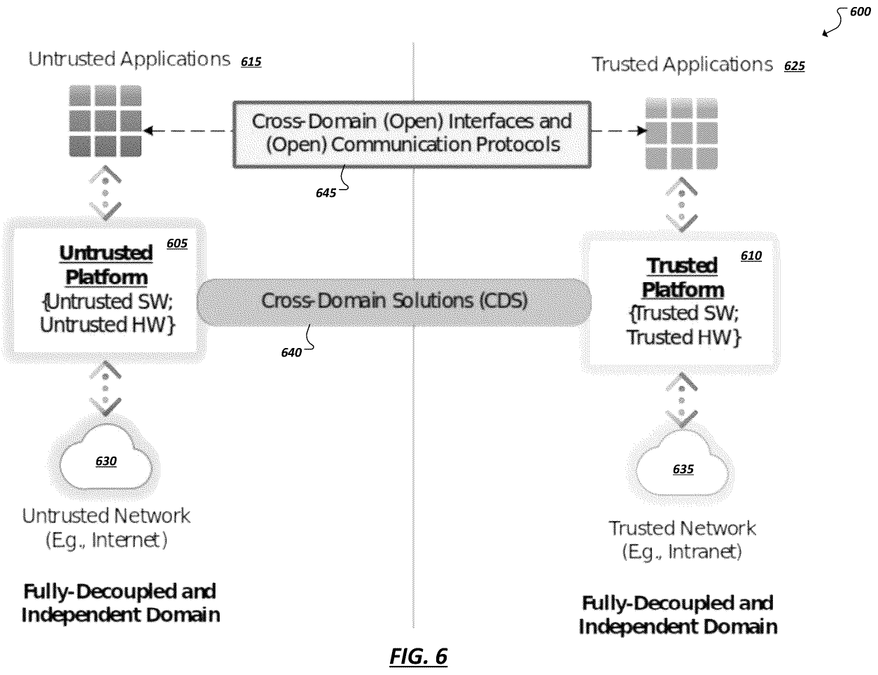

As noted above, M-CDS devices may be deployed within systems to provide secure and custom interfaces between devices (e.g., in different layers) in different domains (e.g., of distinct proprietary networks, different owners, different security or trust levels, etc.) to facilitate the secure exchange of information between the two or more domains. A CDS may function as a secure bridge between different, otherwise independent sources of information, allowing controlled data flow while keeping each domain separate and protected. FIG. 6 is a simplified block diagram 600 illustrating an overview of an example CDS implementation. For instance, two different platforms 605, 610 may be provided, which include respective processing hardware to execute respective operating systems, applications, and other software. One of the platforms (e.g., 605) may be considered an untrusted domain and executed untrusted applications 615 (e.g., based on the lack of security or trust features in its hardware or software, the identity or characteristics of the owner or provider of the platform 605, its coupling to an untrusted or insecure network (e.g., 630), etc.) and another one of the platforms (e.g., 610) may be considered or designated a trusted platform executing trusted applications 625 (e.g., based on the identity of the owner, trust execution features in the hardware and/or software of the domain) and coupled to a trusted network 635). A CDS 640 may be implemented between the platforms 605, 610 to implement a cross-domain interface 645 to enable communication and coordination between the platforms without undermining the independence and distinctive trust levels of the respective domains.

In some implementations, a CDS device provides a controlled interface: It acts as a secure gateway between domains, enforcing specific rules and policies for data access and transfer. This ensures that only authorized information flows in the right direction and at the right level of classification (e.g., to maintain the higher requirements and more demanding policies of the higher security domain). The CDS may enable information exchange by allowing for both manual and automatic data transfer, depending on the specific needs of the domains. This could involve transferring files, streaming data, or even running joint applications across different security levels. The CDS may thus be used to minimize security risks. For instance, by isolating domains and controlling data flow, CDS helps mitigate the risk of unauthorized access, data breaches, and malware infections. This may be especially crucial for protecting sensitive information in government, military, and critical infrastructure settings. The CDS may also be used to assist in enforcing security policies in that the CDS operates based on pre-defined security policies that dictate how data can be accessed, transferred, and sanitized. These policies ensure compliance with regulations and organizational security best practices (e.g., and requirements of the higher-trust domain coupled to the CDS).

CDS devices may be utilized to implement solutions, such as a data diode (e.g., to control the passing of data between applications in different domains (e.g., a microservice in an untrusted domain to a microservice in a trusted domain, etc.). The CDS device may enforce one-way data transfer, for instance, allowing data to only flow from one domain (e.g., a high-security domain) to the other (e.g., a lower-security domain). A CDS device may also be utilized to perform network traffic filtering, for instance, to implement customized firewalls and intrusion detection systems to filter network traffic and block unauthorized access attempts. A CDS device may also perform data sanitization, such as through data masking and redaction, for instance, to remove sensitive information from data (e.g., before it is transferred to a lower-security domain). A CDS device may further implement a security enclaves to provide an isolated virtual environment that can be used to run applications or store sensitive data within a lower-security domain while maintaining a high level of protection, among other examples.

CDS implementations may be used to safeguard sensitive data across various critical sectors, from the high-speed world of automotive engineering to the delicate balance of healthcare information. For instance, CDS may empower secure data exchange in a variety of domains. For example, CDS may benefit automotive applications, such as connected cars, which may assume vehicles exchanging real-time traffic data, safety alerts, and even software updates across different manufacturers and infrastructure providers. CDS may be used in such environments to ensure secure communication between these disparate systems, preventing unauthorized access and protecting critical driving data. Further, in autonomous driving applications, as self-driving cars become reality, CDS may be invaluable for securing communication between sensors, onboard computers, and external infrastructure like traffic lights and V2X (vehicle-to-everything) networks. This ensures reliable data exchange for safe and efficient autonomous driving.

CDS devices may be deployed to enhance computing systems in other example industries and applications. For instance, CDS may be employed within financial applications, such as secure data sharing. For instance, CDS may be used to facilitate secure data exchange between banks, credit bureaus, and other financial institutions, enabling faster loan approvals, better risk assessments, and improved customer service. As another example, CDS may be beneficial within healthcare applications. For instance, CDS may be advantageously applied in maintaining patient data privacy. CDS may be used to help to decouple the data in the healthcare providers and securely share patent data between hospitals, clinics, and pharmacies while complying with strict privacy regulations like HIPAA. This ensures efficient patent care while protecting sensitive medical information. CDS may also be employed within telemedicine and remote monitoring by enabling secure communication between doctors and patients during telemedicine consultations and allows for real-time data transfer from medical devices worn by patients remotely. This improves access to healthcare and allows for proactive intervention in critical situations.

Defense and national security applications may also benefit from platforms including CDS devices. For instance, in intelligence sharing, CDS facilitates secure collaboration and information sharing between different intelligence agencies and military branches. This enables quicker response times to threat and improves overall national security. Further, in systems protecting critical infrastructure, CDS safeguards data from critical infrastructure like power grids, communication networks, and transportation systems against cyber-attacks and unauthorized access. This ensures the smooth operation of these vital systems and protects national security, among other example applications and benefits.

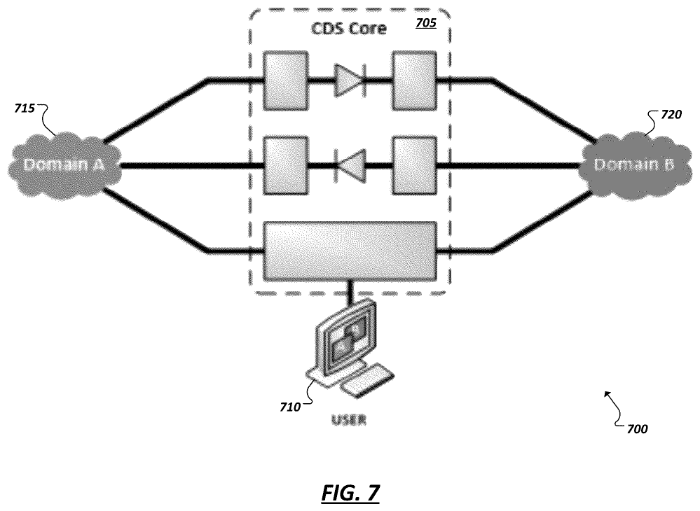

A M-CDS provides a memory-based interface that can be used to transfer the data across multiple hosts in multiple separate domains. The M-CDS device includes a memory to implement a shared memory accessible to two or more other devices coupled to the M-CDS by respective interconnects. The shared memory may implement one or more buffers for the exchange of data between the devices according to customizable policies and/or protocols defined for the shared memory. This common memory space is used to create user-defined buffers to communicate in an inter-process communication manner, but across multiple hosts. Further, logic may be provided in the M-CDS device to perform data masking and filtering of data stored in the buffer (e.g., based on customer-defined policies) so that more fine-grained data control can be performed. As an example, turning to FIG. 7, a simplified block diagram 700 is shown illustrating an example application of a M-CDS device 705. In this example, a user application (e.g., a software-as-a-service (Saas), cloud-based application, etc.) may be implemented (e.g., accessible over a network by one or multiple client devices (e.g., 710)), where the M-CDS device 705 is programmed to implement two shared buffers to enable one-way data exchange between two disparate and independent systems or domains 715, 720. The implementation of the example user application may leverage functionality and/or data provided by and through the cooperation of both of these systems 715, 720. However, due to the independence of the domains 715, 720 (and potentially security, privacy, intellectual property, or other considerations) a direct coupling of the systems 715, 720 may not be possible. In this example, the M-CDS 705 enables custom-defined communication channels through the shared memory buffers, the buffers (in this example) enabled to implement respective unidirectional data channels, or a data diode. In other examples, the same M-CDS device 705 may implement different, customer-defined communication channels through its shared memory and corresponding buffers, including bidirectional communication channels (e.g., using two buffers for each direction). Among the example advantages, an M-CDS device may enable buffers according to flexibly-defined user-defined protocols, custom-defined data formats, non-IP based host-to-host communication, and other communication similar to inter-process communication, but across multiple hosts running over non-IP-networks, among other examples.

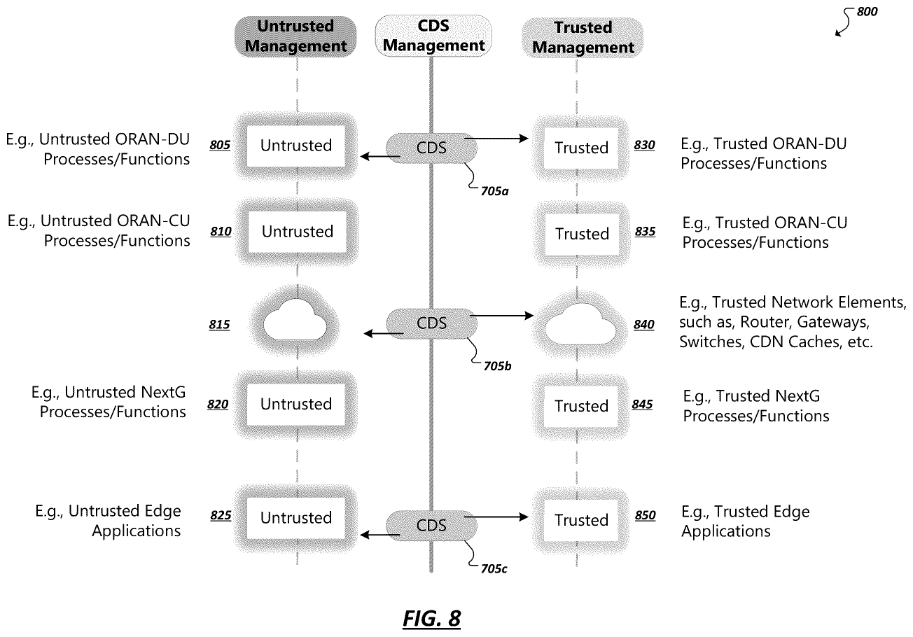

A variety of devices representing independent computing domains may couple to and communicate through an example M-CDS device. FIG. 8 is a simplified block diagram 800 illustrating various solutions utilizing one or more M-CDS devices. For instance, domain devices may include I/O devices (e.g., an FPGA, GPU, storage device, hardware accelerator, which host devices may traditionally access directly via interconnect busses (e.g., PCIe links)), a networking device providing access to an Internet Protocol (IP) IP network (e.g., a virtual or physical network interface card (NIC) that can use a network socket), a memory module that can share the memory space between independent domains that connect to a CDS device (e.g., 705a-c), etc. Some of the domain entities may be regarded as “untrusted” (e.g., based on particular security, privacy, or trust policies and the domain entities failing in one or more regards to meet such policies), while other domain entities couple are regards as “trusted” (e.g., for satisfying the security, privacy, or trust policies), with entities in untrusted domains (e.g., 805, 810, 815, 820, 825, etc.) coupling securely through a M-CDS device 705a-c to the trusted domain entities (e.g., 830, 835, 840, 845, 850, etc.). The shared memory of the M-CDS devices lends enhanced security and control, given its independence from the computing environment domains to which they are coupled to, thereby providing security and isolation as a service to the data being exchanged over the memory-implement interface provided through the M-CDS device.

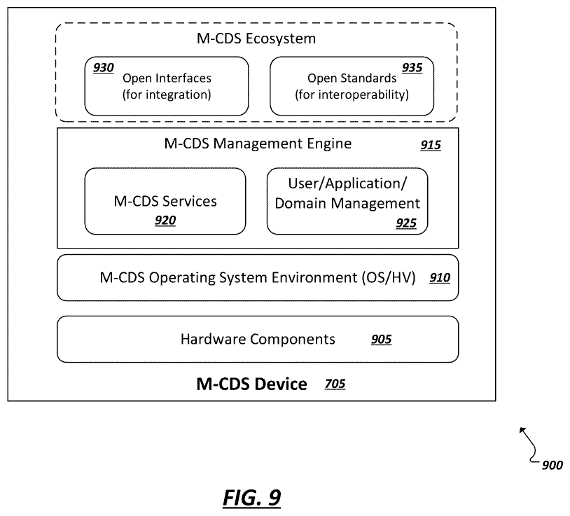

Turning to FIG. 9, a simplified block diagram 900 is shown illustrating an example implementation of an M-CDS device 705. The M-CDS device 705, in this example, may include a variety of hardware components 905 including memory and memory management circuitry, as well as one or more processing elements, including a central processing unit (CPU), hardware accelerators, programmable processor devices, among other examples. In this example, an operating system 910 may run on the M-CDS hardware 905 and support a variety of CDS services and logic implemented on the M-CDS device 705. For instance, a management engine 915 may be implemented to manage memory-based communication channels implemented through the M-CDS device 705. For instance, the management engine 915 may include M-CDS services management 920, including management of the M-CDS device control plane (e.g., to configure the communication channel), M-CDS device data plane (e.g., implementing the communication channel and its constituent policies and protocols), M-CDS device memory management, and the M-CDS databases including records which define the policies, rules, protocols, and configuration of specific M-CDS-implemented communication channels. The management engine 915 may further include management 925 of domains, users, applications, and processes (or communication endpoints), which may couple to the M-CDS device 705 and employ M-CDS device-implemented communication channels, including identifying rules and policies applying to respective endpoints, permission management and authentication of respective endpoints, telemetry reporting, and quality of service (QOS) enforcement, among other examples. One or more multiple communication channels may be established using the logic of the management engine to implement a CDS system that supports channels with multiple different open interfaces 930 and protocol standards 935, which may be custom-configured by the endpoints that are to use the channel.

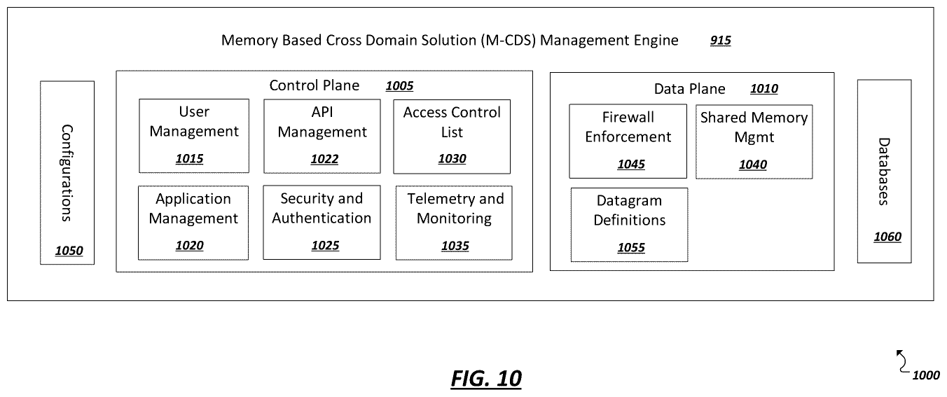

Turning to FIG. 10, a simplified block diagram 1000 illustrating example logical modules of an example M-CDS device, implemented in hardware circuitry, firmware, and/or software executed on the M-CDS device. The management engine 915 may include a control plane manager 1005 and a data plane manager 1010. The control plane manager 1005 may be responsible for managing the configuration and establishment of memory-based communication channels in the M-CDS device. With a channel configured, the data plane management 1010 may manage operation of the channel following configuration, enforcing policies and providing services to be used in the respective CDS channels based on the configurations.

An example M-CDS device may include two or more I/O ports to couple to devices representing different domains. The control plane manager 1005 may interface with the attached devices to present the M-CDS device as a memory device (e.g., RAM device) accessible by the attached devices via their respective interconnect (e.g., a respective PCIe, CXL, Ethernet, or other links). A user manager 1015 may identify a particular device, operating system, hypervisor, etc. of a domain and determine attributes of the corresponding domain, including policies and configurations to be applied for the domain. The user manager 1015 may further identify the various applications (e.g., applications, services, processes, virtual machines, or threads) that are to run on the domain's operating system or hypervisor and that may utilize communication channels implemented by the M-CDS device. An application manager 1020 may identify, for the applications of each domain, attributes, permissions, policies, and preferences for the applications so as to configure the manner in which individual applications will access and use communication channels (and their corresponding buffers) implemented in the M-CDS device. For instance, a single buffer or communication channel configured in the M-CDS to enable communication between two or more domain devices may be called upon, in some implementations, to be used by multiple, distinct applications of a domain, and the application manager 1020 may configure the channel to establish rules and policies that will govern how the applications share the channel, among other example configurations and considerations.

Continuing with the example of FIG. 10, an API manager 1022 may be provided in some implementations to assist in configuring the M-CDS device and respective channels configured in the M-CDS device to interoperate in a system where the M-CDS device couples through an external switch or another M-CDS device to one or more domains, with the communication channel being configured to consider the routing, protocols, and other attributes of the potential one-to-many coupling of the M-CDS device to potentially multiple distinct domains through a single I/O interface of the M-CDS device 705, among other examples. A security and authentication manager 1025 may define and enforce security and authentication protocols (e.g., at the domain or application level) for the channels, such that specific security features and/or policies are configured for the channel. Further, an access control manager 1030 may govern configuration access to the M-CDS device, for instance, enforcing access controls and permissions of the configuration port of the M-CDS device. QoS and telemetry monitoring may also be managed for channels of specific domains and/or applications, for instance, in accordance with QoS guarantees for various domains or applications, and telemetry monitoring access may be controlled using a QoS and telemetry monitoring manager 1035, among other example modules and logical blocks.

The management engine 915 of an example M-CDS device may additionally include data plane management logic 1010 to govern the operation of various communication channels (and corresponding buffers) configured in the memory of the M-CDS device in accordance with the configurations (e.g., 1050) implemented using the control plane manager. Individual buffers and channels may have respective functionality, rules, protocols, and policies defined for the channel, and these channel or buffer definitions may be recorded within a channel database 1060. The data plane manager 1010 may include, for instance, shared memory management engine 1040 to identify a portion of the M-CDS device memory to allocate for a specific communication channel and define pointers to provide to the domain devices that are to communicate over the communication channel to enable the devices' access to the communication channel. The shared memory management engine 1040 may leverage these pointers to effectively “turn off” a device's or application's access and use of the communication channel by retiring the pointer, disabling the device's ability to write data on the buffer (to send data on the communication channel) or read data from a buffer (to receive/retrieve data on the communication channel), among other example functions. Other security and data filtering functions may be available for use in a communication channel, based on the configuration and/or policies applied to the channel, such as firewalling by a firewall manager 1045 (e.g., to enforce policies that limit certain data from being written to or read from the communication channel buffer) or data filtering (e.g., at the field level) performed by a datagram definition manager 1055 that is aware of the data format of data written to or read from the communication channel (e.g., based on a protocol or other datagram format (including proprietary data formats) defined for the channel), to identify the presence of certain sensitive data to filter or redact such data and effectively protect such information from passing over the communication channel (e.g., from a more secure or higher trust domain to a less secure or lower trust domain), among other examples.

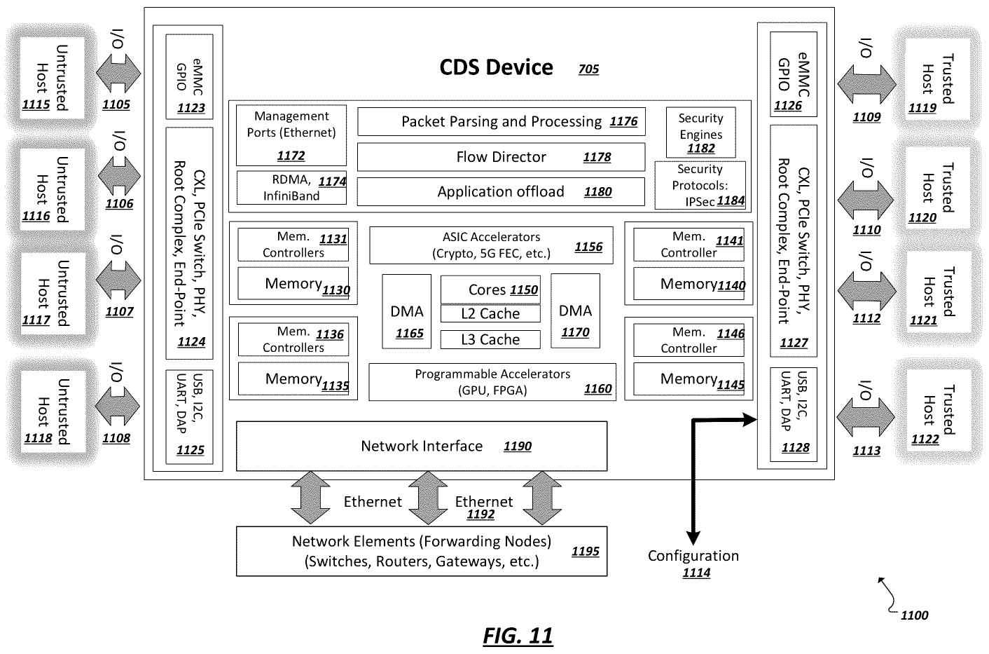

Turning to FIG. 11, a simplified block diagram 1100 is shown illustrating example hardware components of an example M-CDS device 705. An M-CDS device 705 includes two or more ports (e.g., 1105-1113) to couple to various host devices (e.g., 1115-1123) associated with two or more different domains (e.g., domains of different ownership, trust levels, security features or permissions, etc.). Different interconnect protocols may be supported by the various ports 1105-1113 of the M-CDS device 705 (such as PCIe, CXL, Ethernet, UPI, UCIe, NVLink, etc.) and corresponding protocol logic (e.g., 1124-1129) may be provided on the M-CDS device 705 to enable the M-CDS device to connect to, train, and communicate with the host devices (e.g., 1115-1123) over corresponding links. A M-CDS device 705 may also include a network interface 1190 and supporting network controller circuitry to implement one or more ports to couple to one or more networks (e.g., via Ethernet links 1192), thereby allowing the M-CDS device 705 to couple to various network elements 1195, including other network-enabled M-CDS device 705 such as discussed in more detail below. Further, one of the ports or an additional port may be provided as a configuration channel 1114, to enable a user or system to interface with the M-CDS device 705 and configure functionality of the M-CDS device 705, define configurations for connections and communication with the M-CDS device 705 (e.g., by host devices 1115-1122), define policies and rules that may be applied to memory-based communication channels implemented on the M-CDS device 705, configure CDS services provided by through the hardware, firmware, and/or software executed on the M-CDS device 705, among other example features.

The M-CDS device 705 also includes one or more memory elements (e.g., 1130, 1135, 1140, 1145), at least a portion of which are offered as shared memory and implement communication buffers through which buffer schemes may be applied to implement communication channels between two or more hosts (e.g., 1115-1123) through the exchange of data over the buffer(s). The portions of memory 1130, 1135, 1140, 1145 designated for use as shared memory may be presented by the M-CDS device 705 to the host devices (e.g., 1115-1122) as shared memory (e.g., using semantics of the corresponding interconnect protocol through which the host device connects to the M-CDS device 705). Corresponding memory controllers (e.g., 1131, 1136, 1141, 1146, etc.) may be provided to perform memory operations on the respective memory elements (e.g., 1130, 1135, 1140, 1145). The M-CDS device 705 may further include direct memory access (DMA) engines (e.g., 1165, 1170) to enable direct memory access (e.g., DMA reads and writes) by hosts (e.g., 1115-1122) coupled to the M-CDS device 705 and utilizing buffers for communication channels as implemented in the shared memory regions of the M-CDS memory (e.g., 1130, 1135, 1140, 1145).

One or more CPU processor cores (e.g., 1150) may be provided on the M-CDS device 705 to execute instructions and processes to implement the communication channel buffer and provide various CDS services in connection with these buffers (e.g., based on the respective configuration, rules, and policies defined for the buffer). Corresponding cache may be provided, and the processor cores 1150 may cooperate and interoperate with other processing elements provided on the M-CDS device 705, including ASIC accelerator devices 1155 (e.g., cryptographic accelerators, error correction and detection accelerators, etc.) and various programmable hardware accelerators 1160 (e.g., graphics accelerators (e.g., CPU), networking accelerators, machine learning accelerators, matrix arithmetic accelerators, field programmable gate array (FPGA)-based accelerators, etc.). Specialized processing functionality and acceleration capabilities (e.g., provided by hardware accelerators 1155, 1160, etc. on the M-CDS device 705) may be leveraged in the buffer-based communication channels provided through the memory of the M-CDS device 705, based on configurations and rules defined for the channel.

Logic may be provided on the M-CDS device 705 to implement various CDS services in connection with the buffer-based communication channels provided on the M-CDS device 705. Such logic may be implemented in hardware circuitry (e.g., of accelerator devices (e.g., 1155, 1160), functional IP blocks, etc.), firmware or software (e.g., executed by the CPU cores 1150). Functional CDS modules may thereby be implemented, such as modules that assist in emulating particular protocols, corresponding packet processing, and protocol features in a given buffer channel (e.g., providing Ethernet-specific features (e.g., Dynamic Host Configuration Protocol (DHCP)), etc.) using an Ethernet port management module, or RDMA and InfiniBand features using a RDMA and/or InfiniBand module (e.g., 1174). Various packet parsing and processing may be performed at the M-CDS device 705 using a packet parsing module 1176, for instance, to parse packets written to a communication channel buffer and performing additional services on the packet to modify the packet or prepare the packet for reading by the other device coupled to the communication channel buffer. Application management tasks may also be performed, including routing tasks (e.g., using a flow director 1178) to influence the manner in which data communicated over a buffer is consumed and routed by the domain receiving the data (e.g., specifying a process, core, VM, etc. on the domain device that should handle further processing of the data (e.g., based on packet inspection performed at the M-CDS device 705), among other examples). An application offload module 1180 may be leverage information concerning a network connection of one of the devices coupled to the M-CDS device 705 to cause data read by the device to be forwarded in a particular manner on a network interface controller or other network element on the device (e.g., to further forward the data communicated over the M-CDS device 705 communication channel to other devices over the network). In still other examples, the M-CDS device 705 may perform various security services on data written and/or read from a communication channel buffer implemented on the M-CDS device 705, for instance, applying custom or pre-defined security policies or tasks (e.g., using a security engine 1182), applying particular security protocols to the communications carried over the communication channel buffer (e.g., IPSec using a security protocol module 1184), among other example CDS services and functionality.

As introduced above, a traditional IP network may be at least partially replaced using one or more (or a network of) M-CDS devices. M-CDS devices may be utilized to implement cross-domain collaboration that allows information sharing to become more intent-centric. For instance, one or more applications executed in a first domain and the transactions required for communications with other applications of a different domain may be first verified for authenticity, security, or other attributes (e.g., based on an application's or domain's requirements), thereby enforcing implicit security. Memory-based communication may also offer a more reliable data transfer and simpler protocol operations for retransmissions and data tracking (e.g., than a more convention data transfer over a network or interconnect link (which may be emulated by the memory-based communication). Through such simpler operations, M-CDS solutions can offer high-performance communication techniques between interconnecting domain-specific computing environments. Further, the memory interfaces in an M-CDS device may be enforced with access controls and policies for secure operations, such as an enabling a data-diode which offers communications in a unidirectional fashion with access controls, such as write-only, read-only, and read/write permitted. In other instances, the memory-based communication interface may enable bi-directional communication between different domains. In some implementations, separate buffers (and buffer schemes) may be used to facilitate each direction of communication (e.g., one buffer for communication from domain A to domain B and another buffer for communication from domain B to domain A). In such cases, different policies, CDS services, and even protocols may be applied to each buffer, based on the disparate characteristics and requirements of the two domains, among other example implementations. Generally, these memory-based communication interfaces can be a standard implementation and may also be open-sourced for easier use, community adoption, and public participation in technology contributions without compromising the security and isolation properties of the data transactions. The open implementation also provides transparency of communication procedures over open interfaces to identify any security vulnerabilities.

Traditional communication channels may utilize protocols, which define at least some constraints and costs in achieving compatibility between the connected devices and applications that are to communicate over the channel. An M-CDS may enable support for application-defined communication protocols over open interface definitions (and open implementation), allowing customized communication solutions, which are wholly independent of or at least partially based on (and emulate) traditional interconnect protocols. For instance, application-defined communication protocols may enable applications to create their own datagram format, segmentation, encryption, and flow control mechanisms that are decoupled from the protocols used in the M-CDS interfaces (connecting the M-CDS device to host devices) and memory buffers. In some instances, an M-CDS solution only provides the domain systems with physical memory space to communicate and allows the domain systems to specify and define how the systems will communicate over M-CDS memory, with the M-CDS device providing logic that may be invoked by the application-specific definition to perform and enforce specified policies or features desired by the domain systems, among other examples.

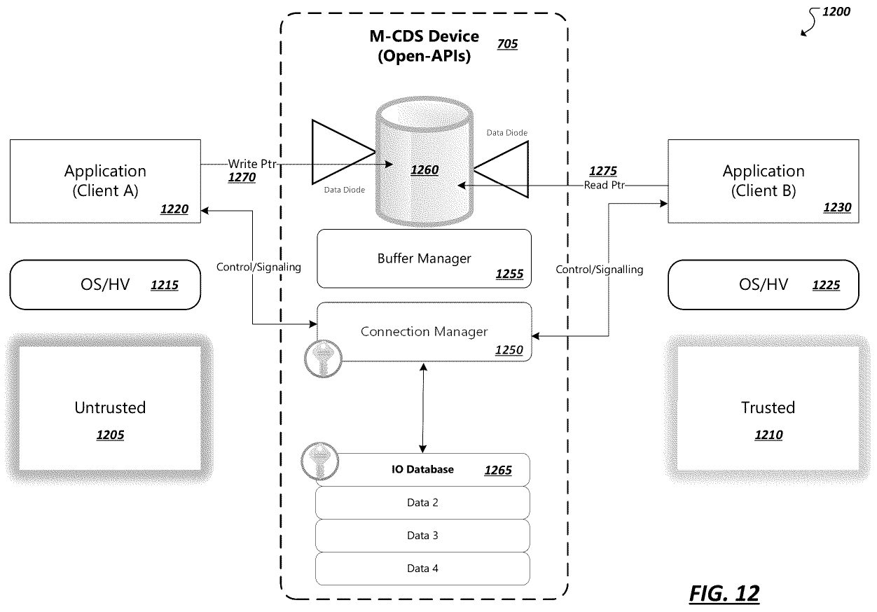

An example M-CDS device may be utilized to implement an M-CDS-based I/O framework (IOFW). The M-CDS device may be incorporated into a system such as that illustrated in the example of FIG. 12. FIG. 12 shows a simplified block diagram 1200 of the system, including an M-CDS device 705 coupled to a first client 1220 (associated with an untrusted domain 1205) and a second client 1230 (associated with a different, trusted domain 1210). In this example, the clients 1220, 1230 may be respective applications run in corresponding operating environments 1215, 1225 (e.g., respective operating systems, hypervisors, containers, etc.) associated with domains 1205, 1210. In other cases, clients may be other types of processes, services, threads, or other software entities. The clients (e.g., 1220, 1230), although provided through independent and disparate domains (e.g., 1205, 1210) may nonetheless be beneficially coupled using an M-CDS to allow the clients to co-function and provide a beneficial service or function (e.g., implement a security application, a defense application, an automotive application, a healthcare application, or a financial application, among other examples.

An IOFW provides a framework for software components in the respective domains of computing nodes to interface with shared memory based inter-process communication (IPC) channels, which are either physical or virtual functions, in a uniform and scalable manner. More specifically, an IOFW provides a framework for establishing and operating a link between any two functional software modules or clients (e.g., applications, drivers, kernel modules, etc.) belonging, in some cases, to independent domains of computing nodes. As an example, a process A (e.g., 1220) of domain X (e.g., 1205) may be linked with a process B (e.g., 1230) of domain Y (e.g., 1210) via a communication channel implemented on a M-CDS device 705. While clients communicating over an IOFW of an M-CDS device, may, in many cases, belong to independent domains (e.g., of independent computing nodes), communication over an M-CDS device (e.g., 705) is not limited to clients operating in different domains. For instance, two clients can belong to the same domain or different domains. An M-CDS device 705 may implement an IOFW that provides a mechanism for setting up both an end-to-end connection and a communication channel buffer (e.g., according to a buffer scheme definition) to support data transfer. To implement the IOFW, an M-CDS device 705 may decouple control (e.g., for connection setup) from the data plane (e.g., for data transfer).

Continuing with the example of FIG. 12, in some implementations, an example M-CDS device 705 may include a connection manager 1250 and a buffer manager 1260, the connection manager 1250 embodying those hardware and logical elements of the M-CDS device 705 that are to implement the control plane of the connection (e.g., to establish and configure the communication channel) and the buffer manager 1255 implementing the data plane using a buffer 1260 implemented in the shared memory of the M-CDS device 705. The connection manager 1250 may interface with respective host devices and clients (e.g., 1220, 1230) to identify requirements, policies, and schemes for a communication channel to be implemented between the clients. The connection manager 1250 may coordinate the negotiation, configurations, and opening of the channel, allowing communication to commence over a buffer implemented in the M-CDS device shared memory that is sized and governed in accordance with the configuration determined using the connection manager 1250. Policies, client identities, protocol definitions, and buffer schemes may be maintained in a database 1265.

In some implementations, an M-CDS device connection manager facilitates the connection setup between clients. Each client (e.g., 1220, 1230) may be expected to request a desired buffer scheme for transmission and receiving, respectively, along with the target clients for the connections. The connection manager 1250, in coordination with the M-CDS database 1265, permits the requested connection by setting up the buffer schemes that will govern the buffers (e.g., 1260) implemented in the M-CDS shared memory to implement a communication channel between the clients (e.g., 1220, 1230). Once the connection is set up, the connections' states, along with tracking information, may be updated to the database 1265 (among other information) to keep the real-time IOFW statistics for the connection (e.g., which may be used by the buffer manager 1255 in connection with various CDS services (e.g., QoS management) provided for the channel). The connection manager 1250 allows the handover of channel ownership so that connection services can be offloaded to other clients (e.g., other services or threads) as permitted by the security policies or other policies of the respective computing domains (e.g., 1205, 1210). The connection manager 1250 may allow suspension of the active connection between two channels (e.g., two channels between clients A and B) to establish a new active connection with another client (e.g., between client A and another client C). In this example, when clients A and B want the resumption of service, the connection between clients A and B can be resumed without losing the previous states of the previously established channels (e.g., during the suspension of the connection between clients A and B), while operating the connection in the M-CDS device 705 between clients A and C, among other illustrative examples. Similar to the client registration for setting up the buffer schemes, the connection manager 1250 may also facilitate the de-registration of channels by one or more of the involved clients, to retire or disable a corresponding buffer, among other examples.

In some implementations, the buffer manager 1255 provides the framework for creating new buffer schemes to define communication channel buffers for use in implementing M-CDS communication channels. Defined buffer schemes may be stored, for instance, in database 1265 and may be recalled to work as a plugin in subsequent communication channels. Buffer schemes may also be configured dynamically. The buffer manager may support various buffer schemes which suit the unique requirements of the clients and new buffer schemes may be introduced to register at run-time. A variety of buffer attributes (e.g., buffer type, buffer size, datagram definitions, protocol definition, policies, permissions, CDS services, etc.) may be specified for a buffer in a buffer scheme and potentially limitless varieties of buffers schemes and buffers may be implemented to scale an IOFW platform for new future requirements corresponding to future clients, such as buffer features supporting Time Sensitive Networking (TSN) Ethernet, Dynamic Voltage and Frequency Scaling (DVFS), global positioning system (GPS) timing use cases to share across domains, among a myriad of other example features.

Buffer schemes define the attributes of a buffer to be implemented within the shared memory of a M-CDS device. A defined buffer handles the movement of data in and out of shared memory, thereby allowing clients (e.g., 1220, 1230) with access to the buffer (e.g., 1260) to exchange data. The buffer 1260 may be configured and managed (e.g., using the buffer manager 1255) to emulate traditional communication channels and provide auto-conversion of schemes between the transmit function of one client (e.g., 1220) to the receive function of the corresponding other client (e.g., 1230) coupled through the buffer 1260. In some implementations, within a buffer, clients (e.g., 1220, 1230) can choose different buffer schemes, for example, a data Multiplexer (MUX) can read data in a serial stream and output high-level data link control (HDLC) frames in a packet stream. On the contrary, a data serializer may convert the parallel data stream to the serial stream using a buffer according to a corresponding buffer scheme. Conversion from one buffer scheme to another may also be supported. For example, an existing or prior buffer scheme that is configured for serial data transmission may be converted to instead support packet data, among other examples. In some implementations, the buffer scheme defines or is based on a communication protocol and/or datagram format. The protocol and data format may be based on an interconnect protocol standard in some instance, with the resulting buffer and M-CDS channel functioning to replace or emulate communications over a conventional interconnect bus based on the protocol. In other instances, a buffer scheme may be defined according to a custom protocol with a custom-defined datagram format (e.g., a custom packet, flit, message, etc.), and the resulting buffer may be sized and implemented (e.g., with corresponding rules, policies, state machine, etc.) according to the custom protocol. For instance, a buffer scheme may define how the uplink and downlink status is to be handled in the buffer (e.g., using the buffer manager). In some instances, standard services and policies may be employed to or may be offered for use in any of the buffers implemented in the M-CDS device to assist in the general operation of the buffer-implemented communication channels. As an example, a standard flow control, load balancing, and/or back-pressuring scheme may be implemented (e.g., as a default) to the data and/or control messages (including client-specific notification schemes) to be communicated over the buffer channel, among other examples.

The database 1265 may be utilized to store a variety of configuration information, policies, protocol definitions, datagram definitions, buffer schemes, and other information for use in implementing buffers, including recalling previously used buffers. For instance, database 1265 may be used for connection management in the M-CDS device 705 to facilitate connection setup, tracking of connection states, traffic monitoring, statistics tracking, and policy enforcement of each active connection. Indeed, multiple concurrent buffers of varying configurations (based on corresponding buffer schemes) may be implemented concurrently in the shared memory of the M-CDS device 705 to implement multiple different concurrent memory-based communication channels between various applications, processes, services, and/or threads hosted on two or more hosts. The database 1265 may also store all information about authorized connections, security policies, and access controls, etc. used in the establishing the connections with the channels. Accordingly, the connection manager 1250 may access the database 1265 to save client-specific information along with connection associations. The access to the connection manager in the M-CDS device 705 may be enabled through the control plane of the CDS ecosystem, independent of the host node domains (of hosts coupled to the M-CDS device 705), among other example features.

In some implementations, an M-CDS device may support direct memory transactions (DMT) where the direct mapping of address spaces are directly between independent domains coupled to the M-CDS device such that applications can directly communicate over shared address domains via the M-CDS device. Further, Zero-Copy Transactions (ZCT) may be supported using the M-CDS DMA engine to allow the M-CDS device to be leveraged as a “data mover” between two domains where the M-CDS DMA function operates to move data between two domains (through the independent M-CDS device 705) without requiring any copies into the M-CDS local memory. For instance, the DMA of the M-CDS device 705 transfers the data from the input buffer of one client (e.g., Client A (of domain X)) to the output buffer of a second client (e.g., Client B (of domain Y)). The M-CDS device may also implement packet based transactions (PBT), where the M-CDS device exposes the M-CDS interfaces as a virtual network interface to the connecting domains such that the applications in their respective domains can use the traditional IP network to communicate over TCP or UDP sockets using the virtual network interface offered by the M-CDS services (e.g., by implementing a first-in first-out (FIFO) queue in the shared memory of the M-CDS device) with normal packet switching functionalities, among other examples.

The M-CDS device may enforce various rules, protocols, and policies within a given buffer implemented according to a corresponding buffer scheme and operating to facilitate communication between two domains coupled to the M-CDS device. As an example, in some instances, the M-CDS device 705 may enforce unidirectional communication traffic in a buffer, by configuring the buffer such that one of the device is permitted read-only access to data written in the buffer, while the other device (the sender) may write (and potentially also read) data to the buffer. Participating systems in an M-CDS communication channel may be provided with a pointer or other memory identification structure (e.g., a write pointer 1270, a read pointer 1275, etc.) to identify the location (e.g., using an address alias in the client's address space) of the buffer in the M-CDS memory (e.g., and a next entry in the buffer) to which a given client is granted access for cross-domain communication. Access to the buffer may be controlled by the M-CDS device 705 by invalidating a pointer (e.g., 1270, 1275) thereby cancelling a corresponding client's access to the buffer (e.g., based on a policy violation, a security issue, end of a communication session, etc.). Further, logic of the M-CDS device 705 may allow data written to the buffer to be modified, redacted, or censored based on the M-CDS device's understanding of the datagram format (e.g., and its constituent fields), as recorded in the database 1265. For instance, data written by a client (e.g., 1230) in a trusted domain may include information (e.g., a social security number, credit card number, demographic information, proprietary data, etc.) that should not be shared with an untrusted domain's clients (e.g., 1220). Based on a policy defined for a channel implemented by buffer 1260, the M-CDS device 705 (e.g., through buffer manager 1255) may limit the untrusted client 1220 from reading one or more fields (e.g., based on these fields identified as including sensitive information) of data written to the buffer 1260 by the trusted application 1230, for instance, by omitting this data in the read return or modifying, redacting, or otherwise obscuring these fields from the read return, among other examples.

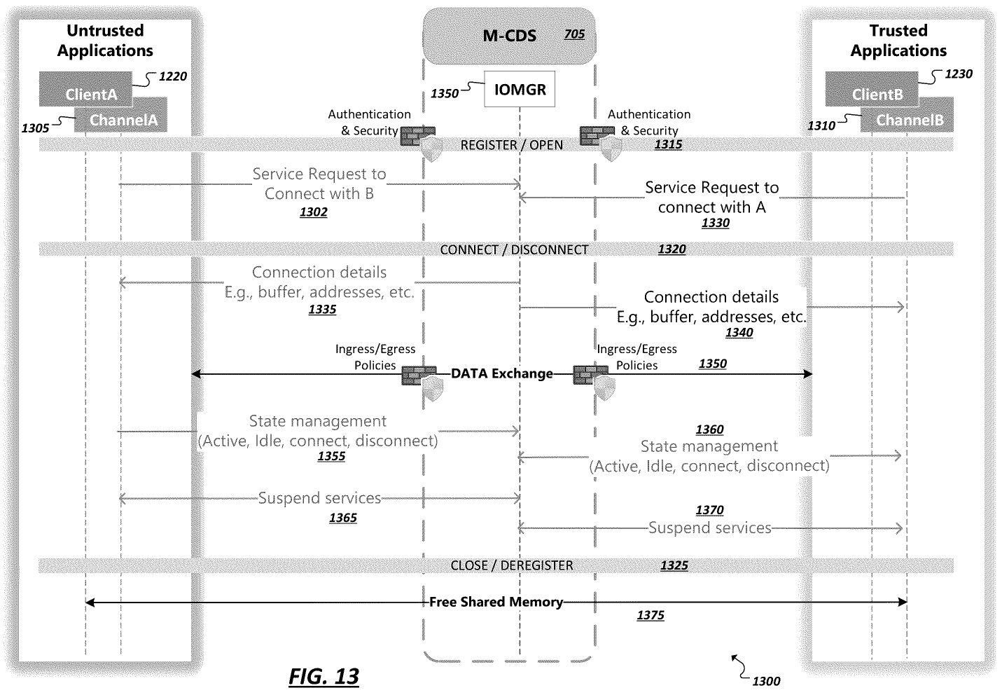

FIG. 13 is a flow diagram 1300 illustrating an overview of the example end-to-end M-CDS operation for two clients, namely client A 1220 and client B 1230, belonging to untrusted 1205 and trusted 1210 domains, respectively, utilizing a M-CDS device 705 for the I/O framework. In this example, client A 1220 sends a request 1302 to the M-CDS device 705 to establish a connection with client B 1230 through the connection manager 1250 of the M-CDS device 705. In some implementations, the flow may be similar to Inter Process Communication (IPC) over shared memory, however the operations over M-CDS involve multiple operating system (OS) domains, and hence require coordination of resources, buffer, and connection management as an independent function of the M-CDS solution. For instance, a Registration phase 1315 may be utilized to register each of the participating clients (e.g., 1220, 1230) with the connection manager 1250, a Connection State Management phase 1320 to control the memory-based links status (e.g., to move between active and deactivated (or idle) link states), and a Deregistration phase 1325 to tear down (or retire) the buffers established in the M-CDS device memory for the link and completing deregistration of the communication channels (e.g., 1305, 1310) of the clients (e.g., 1220, 1230) (e.g., to free up the shared memory for other buffers and communication channels between clients on different domains).

In one example, a Registration phase 1315 may include requests by each of the two or more clients (e.g., 1220, 1230) that intend to communicate on the M-CDS communication channel, where the clients send respective requests (e.g., 1302, 1330) registering their intent to communicate with other clients with the M-CDS 705. The connection manager 1250 may access and verify the clients' respective credentials and purpose of communication (e.g., using information included in the requests and validating this information against information included in the M-CDS database). For instance, an authentication may be performed using the M-CDS-control plane before a given client is permitted to establish communication links over M-CDS memory interfaces. Each established communication link that is specific to the client-to-client connection may be referred to as a “memory channel” (e.g., 1305, 1310). Further, admission policies may be applied to each client 1220, 1230 by the connection manager 1250. In some implementations, the Registration phase 1315 may include an IO Open function performed by the M-CDS device 705 to enables the creation of memory channels (e.g., 1305, 1310) dedicated to each communication link of the pair of clients, in the case of unicast transactions. In the case of multicast/broadcast transactions, the M-CDS device 705 registers two or more clients and acts as a hub where the data from at least one source client (writing the data to the buffer) are duplicated in all the received buffers granted access to the respective destination clients registered on these channels, among other examples.

In a Connection State Management phase 1320 an IO Connect function may be performed by the connection manager 1250 to notify all of the clients registered for a given communication channel to enter and remain in an active state for the transmission and/or reception of data on the communication channel. While in an active state, clients may be expected to be able to write data to the buffer (where the client has write-access) and monitor the buffer for opportunities to read data from the buffer (to receive the written data as a transmission from another one of the registered clients). In some instances, a client can register, but choose not to send any data while it waits for a requirement or event (e.g., associated with an application or process of the client). During this phase, a client can delay the IO Connect signaling after the registration process. Once an IO Connect is successful, then the receiving client(s) is considered ready to process the buffer (e.g., with a closed-loop flow control mechanism). Data may then be exchanged 1335.

The Connection State Management phase 1320 may also include an IO Disconnect function. In contrast to IO Connect, in IO Disconnect, the connection manager 1250 notifies all clients (e.g., 1220, 1230) involved in a specific memory channel to transition to inactive state and wait until another IO Connect is initiated to notify all clients to transition back to the active state. During the lifetime of client-to-client communication session over M-CDS, each participating client (e.g., 1220, 1230) in a memory channel can potentially transition multiple times between active and inactive states according to data transfer requirements of the interactions and transactions between the clients and their respective applications.

A Deregistration phase 1325 may include an IO Close function. In contrast to IO Open, the IO Close function tears down or retires the memory reservations of the memory communication channels used to implement the buffers configured for the channel. A client can still be in the registered state, but the connection manager 1250 can close the memory communication channels to delete all the buffers that have been associated with the memory channels in order to free up the limited memory for other clients to use. Should a change in the activity or needs of the clients change, in some implementations, the memory communication channels may be reopened (through another IO Open function), before the client are deregistered. The Deregistration phase 1325 also includes an IO Deregister function to perform the deregistration. For instance, in contrast to IO Register, IO Deregister is used by the clients to indicate their intent to M-CDS device to disassociate with other client(s) and the M-CDS itself (e.g., at least for a period of time until another instance of the client is deployed and is to use the M-CDS). In the IO Deregister function, the M-CDS device clears the client's current credentials, memory identifiers (e.g., pointers), and other memory channel-related data (e.g., clearing such information from the M-CDS device database), among other examples.

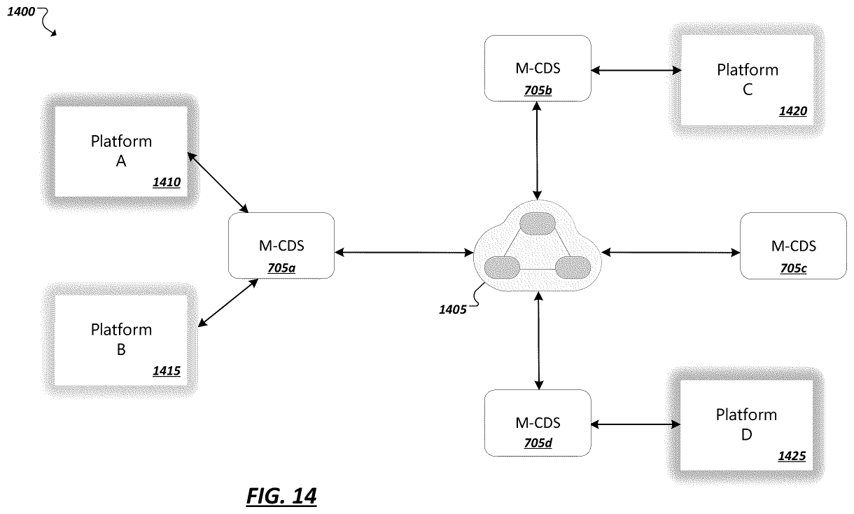

Advanced applications such as Large Language Models (LLMs) require very high computational and networking demands, which tax the capabilities of traditional server architectures in datacenter. Further, edge systems may struggle to keep pace with the massive data transfers and real-time processing in LLMs and other demanding applications. In some implementations, a network of interconnected M-CDS devices may be utilized to assist in providing a CDS for use in high-volume computing and networking application, such as AI- and machine-learning based applications and training of corresponding models. In some implementations, an M-CDS device may include network interface capabilities or may be implemented in a device (e.g., a smart NIC, IPU, DPU, etc.) compute and networking functionality. For instance, turning to FIG. 14, a simplified block diagram 1400 is shown illustrating multiple M-CDS devices (e.g., 705a, 705b, 705c, 705d, etc.) with network interfaces coupled to one another through a network 1405. The interconnected M-CDS devices (e.g., 705a, 705b, 705c) may be coupled to various respective computing platforms (e.g., 1410, 1415, 1420, 1425) and allow these platforms to open memory-based communication channels through the respective shared memories of the M-CDS devices (e.g., 705a, 705b, 705c). In a networked M-CDS architecture, a buffer may be configured within a given M-CDS device (e.g., 705a) and granted access to platforms (e.g., 1420) not directly coupled to the M-CDS device (e.g., 705a), such as platforms coupled to one of the other M-CDS device (e.g., 705b, 705c) coupled to the M-CDS device 705a in the network 1405.

In some implementations, an M-CDS device (e.g., 705a-c) may integrate both compute and networking to enable more intelligent interconnections between M-CDS device in a network, such as in the example of FIG. 14. Implementing such a computing and interconnect fabric continuum can implement a super-compute group or large compute cluster to support a variety of modern and increasingly demanding applications (e.g., LLMs). An integrated M-CDS system may seamlessly integrate M-CDS devices within existing computing elements such as FPGAs, IPUs, DPUs, resulting in a higher-performance fabric, enabling ultra-fast, ultra-dense data transfers and low latency interactions, among other example advantages. Further, through the use of interconnected M-CDS devices, applications may define custom data paths and memory buffers, enabling advanced applications and their developers to run demanding application workloads (e.g., LLM workloads) to run natively on existing infrastructure, without the need for specialized processing units such as NVLink switches, GPUs, and other components, among other examples. Such flexibility may challenge existing technologies, which focus more on intra-node communication, have limited scalability, require vendor lock-in, and are of high cost to application developers, among other example issues.

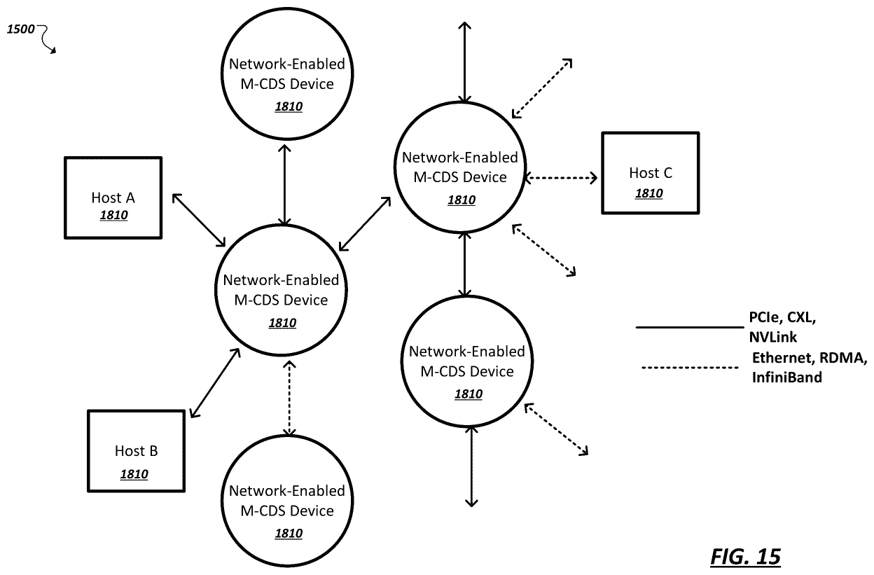

Turning to the simplified block diagram 1500 of FIG. 15, a base case of an M-CDS implementation may involve two devices (e.g., 1410, 1415) corresponding to two, different independent domains coupling to a single M-CDS device (e.g., 705a) to implement a cross-domain communication channel. The local I/O connections of the devices 1410, 1415 to the CDS device 705a may be facilitated by a wired or wireless communication channel, such as link compatible with a conventional I/O interconnect protocol (e.g., PCIe, CXL, NVLink, etc.). In a networked M-CDS implementation, M-CDS devices may include network interfaces utilizing other networking protocols to enable longer-range connections and leveraging of the routing capabilities of networking technologies such as Ethernet, InfiniBand, RDMA, and others. M-CDS devices (e.g., 705a-e) may be interconnected using either I/O interfaces (e.g., 1420) or network interfaces (e.g., 1425) and form an M-CDS backplane. For instance, an example IPU may include an M-CDS block, together with three I/O (e.g., PCIe) interfaces and four networking (e.g., Ethernet) interfaces. These PCIe interfaces can be interconnected (with I/O interfaces of other M-CDS devices) to create a PCIe backplane, and the Ethernet ports can be connected (with networking interfaces of other M-CDS devices) to create an Ethernet backplane. These interconnected backplanes may create the scale-in and scale-out connectivity required for the high bandwidth and low latency communication demanded in emerging applications. Host devices (e.g., 1410, 1415, 1420, etc.) can be connected to various M-CDS devices using either the I/O or the networking backplane. Various architectures may be realized using interconnects based on I/O and/or networking connection capabilities of an M-CDS device (or networking device with M-CDS capabilities). For instance, a hybrid approach may be adopted, which leverages both I/O and network interfaces to offer a balance between performance, scalability, and cost. To realize intra-node efficiency, an I/O-focused backplane (e.g., built on PCIe or CXL) may be utilized to enable enables high-bandwidth, low-latency communication between closely coupled M-CDS devices (e.g., IPUs with M-CDS) within a node for optimal intra-node performance. Inter-node scalability may be realized through a network-focused backplane (e.g., based on Ethernet) to facilitate scaling the system to accommodate larger numbers of nodes, enabling communication across a larger system utilized to implement a high-demand application. Dual backplane design may also allow connecting hosts to both I/O interfaces for high-bandwidth data transfers and network interfaces for broader system access, among other example features.

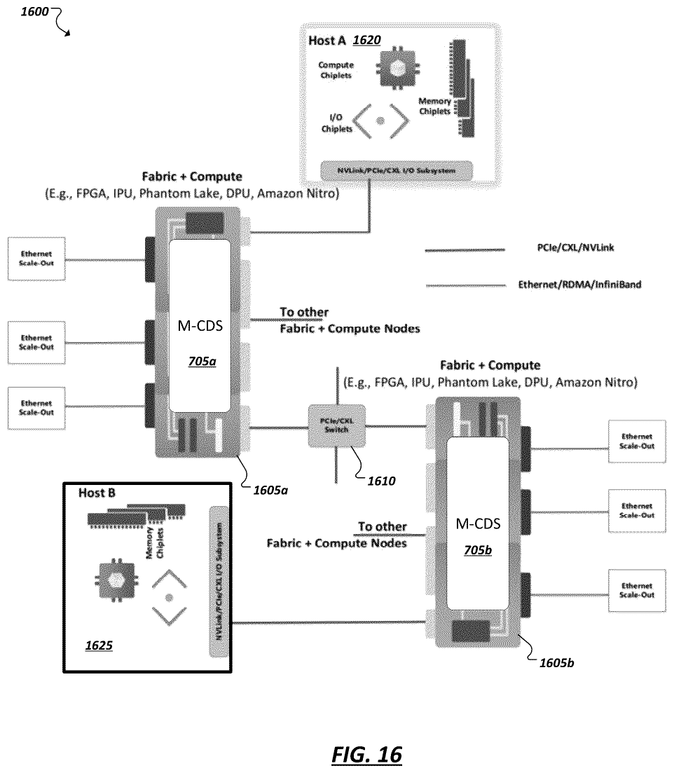

An M-CDS device may be integrated on a device, which includes both compute and network-processing (or fabric) hardware, to enable the M-CDS device to handle network processing workloads, data pre-processing, network processing acceleration, M-CDS control tasks, and other functionality. In one example, IPU, DPU, or smartNIC devices may include an M-CDS block to implement respective shared memory and memory-channel buffer management and communications using the M-CDS block. For instance, as illustrated in the block diagram 1600 of FIG. 16, a first network processing device 1605a (e.g., an IPU) may include an M-CDS block 705a and couple to another network processing device 1605b (with its own instance of an M-CDS block 705b) via switch 1610 (e.g., an I/O backplane switch, such as a PCIe or CXL switch). The network processing devices 1605a-b may include network interfaces (e.g., integrated network interface controllers (NICs)) to couple the network processing devices 1605a-b to other (e.g., remote) devices over a network backplane. Hosts (e.g., 1620, 1625) coupled to the IPUs may make use of the IPUs' network functionality to communicate over the network backplane with remote systems and the M-CDS blocks may enable CDS communications between the host devices.

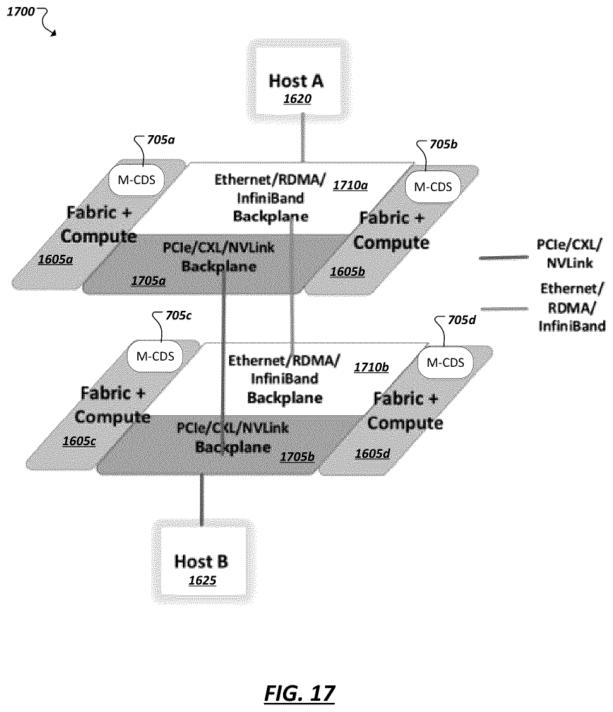

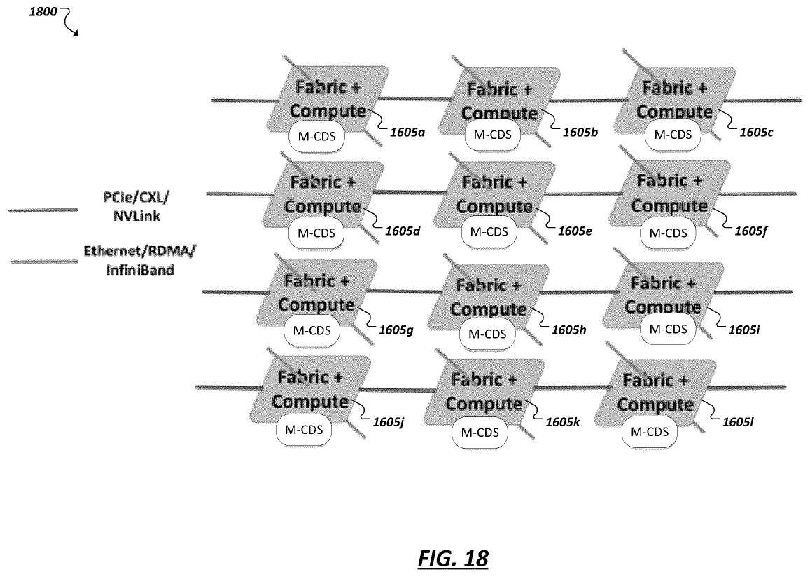

FIG. 17 is a simplified block diagram 1700 illustrating dual backplanes implemented using example network processing devices 1605a-d (e.g., FPGA devices, IPUs, DPUs, smartNIC devices, etc.), which respectively include both I/O interfaces and network interfaces to couple to one or more I/O backplanes 1705a-b (based on one or more I/O protocols) and one or more networking backplanes 1710a-b. The network processing devices 1605a-d may include M-CDS blocks (e.g., 705a-d) and the backplanes 1705a-b, 1710a-b may be used to implement a network of interconnected M-CDS logic to implement M-CDS communication channels between hosts (e.g., 1620, 1625) coupled to one of the I/O or network backplanes to enjoy the benefits of the M-CDS network. FIG. 18 is a simplified block diagram 1800 illustrating a scaled-out network of M-CDS-enabled network processing devices (e.g., 1605a-l) interconnected via a combination of I/O and network backchannels, such as in the example of FIG. 17.

An M-CDS compute and fabric continuum implemented through interconnected M-CDS network processing device may depart from traditional data center architectures in a variety of aspects. For instance, the system may facilitate application-defined data movement, where instead of relying on operating system (OS)-level protocols, applications control data movement directly, achieving performance gains tailored to their respective workloads. Through the M-CDS functionality, diverse computing resources may be integrated within a unified fabric to leverage the respective specialized capabilities of these heterogeneous devices. Further, applications may be allowed to manage memory across the entire fabric, enabling efficient sharing and utilization of memory resources in a disaggregated manner. The integration of an M-CDS with a network processing device may leverage the familiarity cloud system managers have with network processing devices, such as IPUs, together with the high speed, non-IP based communication functionality of network processing devices, which may also provide secure network communication to protects against traditional IP network attacks, among other benefits. Through the custom-defined buffer-based communication channels, applications can define data structures, flow control mechanisms, and synchronization primitives specific to their requirements using the integrated M-CDS functionality, thereby maximizing efficiency for unique communication patterns. Further, M-CDS may enable applications to have granular control over data movement, enabling proactive resource management and adaptation to dynamic network conditions, among other example benefits.

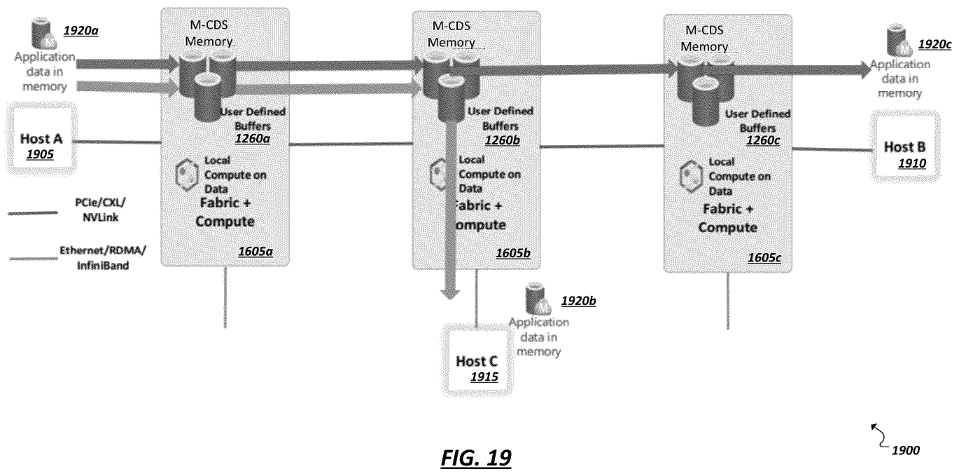

Turning to the simplified block diagram 1900 in FIG. 19, an example implementation of a system is shown that includes multiple network processing devices 1605a-c interconnect using a combination of network interfaces and I/O interfaces. Various host devices 1905, 1910, 1915 participating in the implementation of a given application are connected to respective network processing devices 1605a-c. The movement of application data (e.g., 1920a-c) may be facilitated through the CDS communication channels implemented through user-defined buffers (e.g., 1260a-c) in shared memory of the network processing devices 1605a-c (as governed using M-CDS blocks). Host devices (e.g., 1905, 1910, 1915) may couple to the network processing devices using the I/O interfaces or the network interfaces of the network processing devices and the manner in which host devices are coupled and the data flows selected by an application may be based on strategically leveraging host devices connected by an I/O interface or network interface. In one example, an application (e.g., to implement or train an LLM or other neural network) may distribute portions of application data and the application's workloads to various host devices and nodes interconnected using a network or M-CDS-enabled network processing devices (e.g., 1605a-c). User-defined communication protocols (UDCPs) may be leveraged on a hybrid fabric can be built such that various compute nodes are interconnected to the network, including diverse computing elements (e.g., FPGAs, CPUs, GPUs, accelerators, etc.) with features which may be leveraged to specific application tasks or workloads (e.g., FPGAs for preprocessing, accelerators for core language processing, CPUs for control and management, etc.). In some implementations, a hybrid fabric may select to use high-bandwidth, low-latency I/O connections (e.g., PCIe) to interconnect devices within a single node (or intra-node) for efficient data transfers and low communication overhead and may use network interfaces to implement inter-node connections, enabling communication between nodes (e.g., using Ethernet) across the entire collection of devices used by the application to perform its workloads.

As noted above, applications leveraging a network of M-CDS devices may implement and utilize a UDCP layer, where each node coupled to the network runs a UDCP layer responsible for data plane protocols, data management, and fabric management. Applications may define custom data plane protocols tailored to their specific communication needs, bypassing traditional TCP/IP limitations. Applications may also define data management by directly allocating and managing M-CDS memory buffer definitions across the fabric, optimizing memory usage and reducing data movement overhead. The UDCP layer may interact with the underlying I/O-networking hybrid fabric (e.g., PCIe/Ethernet) to further ensure efficient data routing and congestion control.

Continuing with the above example, an application may specify the source and destination devices, defines required buffers, and set relevant UDCP protocol parameters to define and initiate data transfer within the application. The UDCP layer may orchestrate data descriptors, buffer allocations, and routing and flow control. For instance, the UDCP may construct and exchange metadata packets describing the data to be moved in the application workloads (e.g., data location, type, size, recipient, etc.). The UDCP may work to allocate and manage the memory buffers across the fabric based on application requirements and may determine (based on these configurations) the ideal or desired data path(s) through the fabric, for instance, to ensures congestion-free data flow. With the data paths configured, data is transferred within the application workloads directly between devices across the fabric using the chosen UDCP protocol, thereby bypassing traditional OS network stacks. Devices participating in the application workloads may synchronize using defined UDCP mechanisms to ensure data integrity and notify the application upon completion, among other example features. Configuring and implementing an application utilizing a hybrid, M-CDS-enabled fabric may yield higher performance, scalability, flexibility, and heightened resource control, among other example benefits. For instance, UDCPs and hybrid fabric may enable tailored communication patterns, optimizing data transfers and minimizing latency in the application workloads. The inclusion of the networking protocol backplane(s) in the fabric facilitates scaling the system to accommodate larger and more complex deployments (e.g., for handling likewise large and complex workloads (e.g., LLMs)). User-defined protocols allow applications to adapt communication to specific workloads (e.g., a specific machine learning model design), potentially achieving superior performance over generic solutions. Further, applications are provided with more direct control over memory and communication resources, enabling efficient utilization and optimization, among other example advantages.

UDCPs offer a powerful tool for optimizing communication in specific scenarios, particularly those involving high-performance computing and specialized networks. UDCPs may go beyond traditional protocols like TCP/IP by allowing applications to directly define how data is transferred and managed, potentially unlocking significant performance gains and increased flexibility. UDCPs may define data descriptors, such as metadata associated with data transfers, including its location, size, and intended recipient. UDCPs may define customer flow control mechanisms to manage data flow across the fabric to avoid congestion and ensure efficient buffer utilization. UDCP synchronization primitives may also be defined to coordinate actions between devices, ensuring data consistency and integrity across the system. In some implementations, UDCPs may include custom message formats, routing algorithms, and security measures tailored to a corresponding application's needs and functionality. A UDCP may leverage DMA functionality (e.g., Remote Direct Memory Access (RDMA)) to enable direct data transfer between application buffers without CPU involvement, offering low latency and high bandwidth for data center applications. Virtualization (e.g., SR-IOV, SIOV, etc.) may also be supported within a UDCP, such that an application may directly manage network adapters or other virtualizations, bypassing the operating system kernel for improved performance and control. UDCPs may also be tuned to the specific hardware in the nodes coupled to the network, such as protocols leveraging the programmability of a FPGA, smartNIC, or other component to define specialized protocols optimized for specific workloads, among other example uses and features.

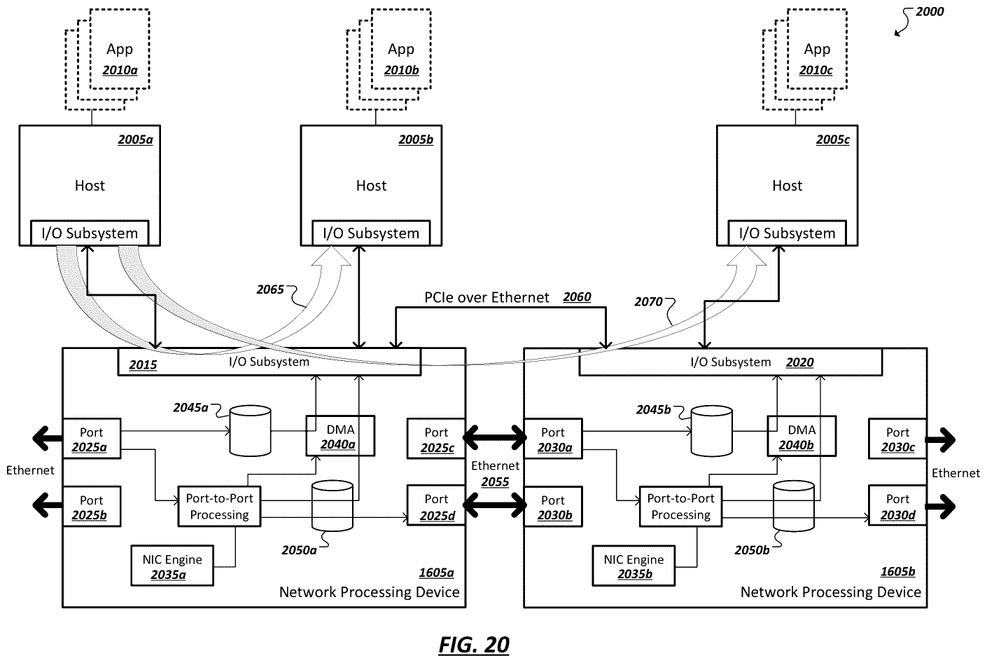

Turning to the simplified block diagram 2000 of FIG. 20, an example implementation of interconnect M-CDS-enabled network processing devices (e.g., 1605a, 1605b) is shown, together with example data flows facilitated between host devices (e.g., 2005a-c) coupled to the network processing devices 1605a-b. The hosts 2005a-c may host one or more multiple concurrent applications (e.g., 2010a-c) and utilize the CDS functionality to facilitate at least some of the data transfers and workloads of these applications 2010a-c. The network processing devices 1605a-b may include respective Ethernet ports (e.g., 2025a-d, 2030a-d) to implement the networking interfaces and couple to a networking backplane of a M-CDS network fabric, and may further include respective I/O subsystems 2015, 2020 (e.g., implementing one or more I/O protocols such as PCIe, CXL, NVLink, etc.) to couple to an I/O backplane of the fabric. In this example, network processing device 1605a is coupled to network processing device 1605b through their respective networking interfaces (e.g., 2025c-d, 2030a-b) to implement an Ethernet connection 2055 between the device 1605a-b. In some implementations, an I/O protocol may still be used between the network processing device 1605a-b, for instance by tunneling some I/O traffic over Ethernet (e.g., PCIe over Ethernet 2060, among other examples).

Continuing with the example of FIG. 20, individual networking processing devices (e.g., 1605a-b) may include respective NIC circuitry (e.g., 2035a-b) and respective port-to-port processing circuitry (e.g., 2075a-b) to efficiently route data within the network processing devices to the appropriate networking or I/O ports, as well as to DMA engines (e.g., 2040a-b) and/or M-CDS buffers (e.g., 2045a-b, 2050a-b) implemented in the network processing devices. For instance, the network processing device 1605a may receive some data that bypasses M-CDS functionality and may be simply routed from one port (e.g., 2025a) of the network processing device (e.g., 1605a) to another (e.g., 2015, 2025c, etc.) for transport to another system (e.g., one of its connected hosts (e.g., 2005a-b), another networking processing device (e.g., 1605b), or some other device). Other data may be routed to the network processing device's M-CDS block to be transferred using a buffer implemented in memory of the network processing device. M-CDS buffers may be configured according to a corresponding buffer scheme and may be implemented with a variety of different characteristics. M-CDS buffers may include store-and-forward-type buffers (e.g., 2045a-b), where the receiver is to read from the buffer to “receive” the data, as well as streaming or “cut-through” buffers (e.g., 2050a-b), where DMA logic (e.g., 2040a-b) is used to stream data, zero-copy, directly into the destination node memory, among other example implementations. Such functionality may be used to move application data of a given application (e.g., 2010a) to another host (e.g., 2005b-c), which may include hardware or software functionality, which the application is attempting to leverage in connection with one or more of its workloads or threads. Such data transfers may include M-CDS memory buffer transfers (e.g., 2065) where the receiving host (and domain) (e.g., 2005b) is coupled to the fabric's I/O backplane, as well as M-CDS memory buffer transfers (e.g., 2070) where the receiving domain (e.g., 2005c) uses the fabric's networking backplane, among other examples, which may be flexibly and scalably configured using the combined power of M-CDS and a hybrid fabric facilitated by a network of interconnect M-CDS-enable network processing devices (e.g., 1605a-b).

In some implementations, a buffer (e.g., 2045a) is used to implement a memory-based communication channel in a network processing device 1605a between a first host (e.g., 2005a) and a second host (e.g., 2005c), wherein the second host 2005c accesses the (remote) buffer 2045a via the network processing device 1605b to which it is directly connected (e.g., via an I/O interconnect connection). The application 2010a hosted on host 2005a may write to the buffer 2045 through its I/O connection with network processing device 1605a and the receiving application 2010c (hosted on the second host 2005c) may perform a read of the buffer 2045 by submitting the read request to the network processing device 1605b, which may route the request to the buffer 2045a over the network connection 2005 coupling the networking processing device 1605b to the network processing device 1605a hosting the buffer 2045a. Likewise, a corresponding read completion providing the data to the destination application (e.g., 2010c) may be routed over the network connection 2005 to be provided to the host 2005c by the network processing device 1605b over the I/O subsystem 2020. Where a bi-directional communication channel is to be implemented, two buffers (one for each direction of data transfer) may be implemented. In some implementations, where the buffer used to channel data from host 2005a to host 2005c is implemented in memory of network processing device 1605a, the buffer configured to implement the channel from host 2005c to host 2005a may be implemented in either the shared memory of networking processing device 1605a or the shared memory of network processing device 1605b (e.g., in buffer 2045b). In either case, one of the hosts 2005a,c will need to use its “local” network processing device 1605a,b to access the buffer (via network connection 2055). In the case of a streaming buffer, or zero-copy queue, the DMA engines (e.g., 2040a-b) of the networking processing devices 1605a-b may be used to DMA a write from a zero-copy queue (e.g., 2050a or 2050b) across the network connection 2055 coupling the two (or more) network processing devices 1605a-b to push data written to the zero-copy queue (from the source application (e.g., 2010a)) to destination memory in the receiving host (e.g., 2005c) over the network connection 2055, among other example configurations, such as defined by an application's buffer configuration request and corresponding buffer scheme.

In some application workloads, an M-CDS-enabled fabric system may be utilized to facilitate memory transactions between nodes coupled to the fabric. Inter-node transactions memory transaction may primarily occur across the network backplane, while intra-node memory transactions utilize the high-bandwidth I/O backplane. In the case of an inter-node memory transaction, an application may trigger the transfer, for instance, by specifying the source and destination memory locations across different nodes, along with the data size and potentially additional parameters. A UDCP layer on each node may interact with the application and construct data descriptors containing transfer metadata (source/destination addresses, size, etc.). Based on the UDCP information and network state, the networking backplane switches (e.g., Ethernet switches) may route data packets containing the actual data and associated metadata toward the destination node. Flow control mechanisms within the UDCP protocol may be utilized to prevent congestion and ensure efficient data delivery. At the destination node, the UDCP layer receives the data packets, buffers them temporarily, and transfers them to the specified memory location. Synchronization mechanisms (e.g., handshakes) may be used to ensure data integrity and notify the application of completion.

In the case of an intra-node memory transaction, an application may likewise initiate the transfer, for instance, by specifying the source and destination memory locations within the same node, along with relevant parameters. In some implementations, instead of involving the UDCP layer and networking backplane, the I/O backplane (e.g., PCIe-based) directly connects devices within the node and the data may be transferred directly between device memory spaces through I/O interconnect lanes, offering significantly higher bandwidth and lower latency compared to a networking protocol, such as Ethernet. Further, synchronization mechanisms within the node (e.g., shared memory or dedicated control registers) may be used to ensure data consistency and notify the application upon completion.

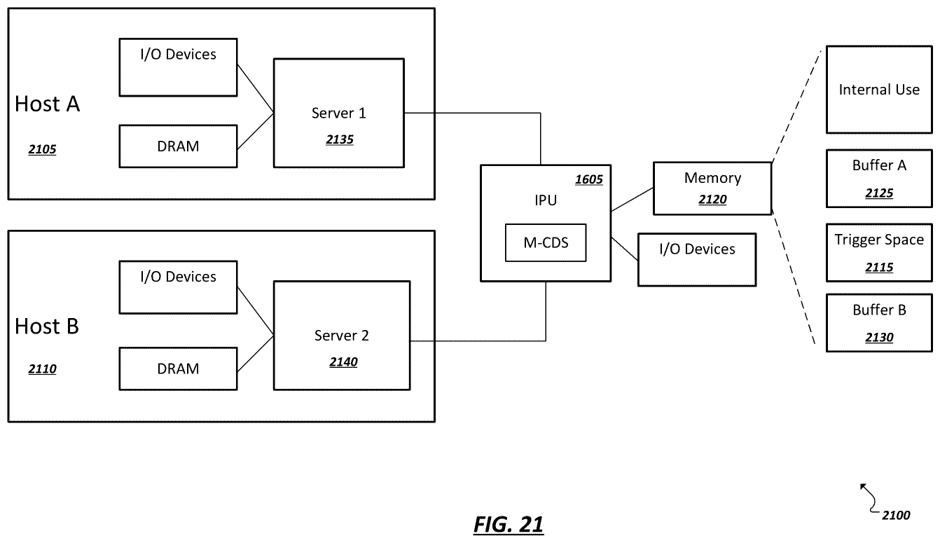

In the example of FIG. 21, two host devices 2105, 2110 (e.g., implementing servers 2135, 2140) in different domains are to exchange data securely and efficiently. A network processing device 1605 outfitted with M-CDS functionality may act as a powerful intermediary, enabling direct memory-to-memory transfers between the hosts without accessing the hosts' respective CPUs. This approach may significantly reduce latency and improves overall performance. In one example implementation, each of the hosts 2105, 2110 may allocate dedicated memory buffers (e.g., 2125, 2130) in the shared memory (e.g., 2120) of the M-CDS-enabled network processing device 1605. In this example, host 2105 writes to its buffer, specifying the target buffer on the network processing device 1605 for the other host 2110. The network processing device may intercept the transaction utilizing its M-CDS hardware, verify authorization, and transfer the data from the buffer (e.g., 2125) of host 2105 to the buffer (e.g., 2130) of host 2110. The receiving host can access the received data directly from its own network processing device buffer to effectively bypass the traditional network stack and CPU involvement, leading to faster and more efficient data exchange.

In some implementations, to receive real-time updates about memory transactions and other events, a trigger spaces (e.g., 2115) may be implemented in the shared memory of the network processing device 1605. The trigger space may serve as a reserved area within the network processing device 1605 memory 2120 that hosts 2105, 2110 coupled to the network processing device 1605 can write specific values into to trigger pre-defined actions. The trigger space can function like a doorbell for the network processing device 1605, such that when a given host (e.g., 2105, 2110) writes a specific value to its trigger space, the network processing device 1605 can send notifications (e.g., alert a host about an event (e.g., using the network or dedicated notification channels) or trigger actions, such automatically initiating pre-programmed logic within the network processing device 1605, such as data processing or security checks. The provision of a trigger space 2115 may enable efficient communication and allow hosts to react dynamically to events occurring on the IPU.

In some implementations, to attempt to optimize resource utilization and avoid unnecessary polling, the network processing device 1605 may provide memory monitors implemented as hardware logic to detect specific changes in memory locations. Memory monitors may way up a sleeping host, trigger actions, among other example functionality. For instance, a memory monitor, upon arrival of data in a buffer corresponding to a sleeping host, may cause the network processing device 1605 to send a wake-up signal to bring the sleeping host back online to process the data in the buffer. Similar to trigger spaces, memory monitors can also trigger predefined actions within the network processing device 1605 upon detecting specific changes in memory (e.g., to reduce unnecessary host wake-ups and improve overall system efficiency), among other example features.

While a network processing device 1605 may facilitate direct memory-to-memory transfers, hosts may still need to exchange control information or larger data sets. In some implementations, this can be achieved through various host-to-host communication protocols supported by the network processing device 1605, such as with PCIe or CXL (e.g., wherein the physical interconnection between host is through the PCIe, and hence a high-bandwidth interface for direct communication between hosts and the IPU is established), network protocols (e.g., wherein the network processing device participates in standard network protocols like TCP/IP for communication between hosts (e.g., by emulating a virtual network on either side of host domains), or specialized protocols which CDS logic may employ to optimize secure and efficient data exchange between domains. Some I/O protocols may facilitate DMA transactions and may be value for use within M-CDS implementations. For instance, CXL.mem may be used to facilitate direct byte-addressable access to remote memory attached to a network processing device 1605. Accordingly, in such examples, hosts (e.g., 2105, 2110) can use such protocols to directly read and write to each other's memory buffers on the network processing device 1605 without limited involvement of the network processing device itself, which may further reduce latency and improve performance, among other example features.

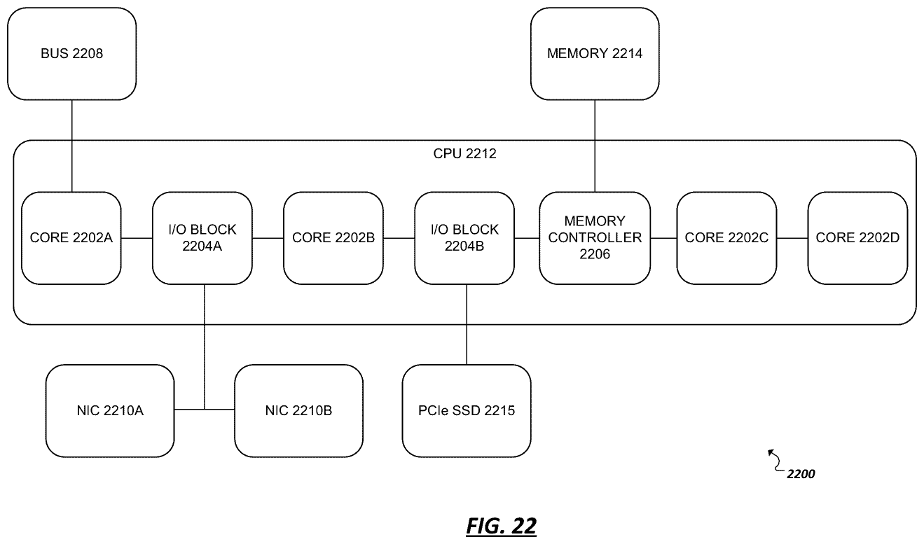

Note that the apparatus', methods', and systems described above may be implemented in any electronic device or system as aforementioned. As a specific illustration, FIG. 22 provides an exemplary implementation of a processing device such as one that may be included in a system or platform in a publish-subscribe architecture, such as discussed herein. It should be appreciated that other processor architectures may be provided to implement the functionality and processing of requests by an example network processing device, including the implementation of the example CDS device components and functionality discussed above.

Referring to FIG. 22, a block diagram 2200 is shown of an example data processor device (e.g., a central processing unit (CPU)) 2212 coupled to various other components of a platform in accordance with certain embodiments. Although CPU 2212 depicts a particular configuration, the cores and other components of CPU 2212 may be arranged in any suitable manner. CPU 2212 may comprise any processor or processing device, such as a microprocessor, an embedded processor, a digital signal processor (DSP), a network processor, an application processor, a co-processor, a system on a chip (SOC), or other device to execute code. CPU 2212, in the depicted embodiment, includes four processing elements (cores 2202 in the depicted embodiment), which may include asymmetric processing elements or symmetric processing elements. However, CPU 2212 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 2212, as illustrated in FIG. 22, includes four cores-cores 2202A, 2202B, 2202C, and 2202D, though a CPU may include any suitable number of cores. Here, cores 2202 may be considered symmetric cores. In another embodiment, cores may include one or more out-of-order processor cores or one or more in-order processor cores. However, cores 2202 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 2202 may include a decode module coupled to a fetch unit to decode fetched elements. Fetch logic, in one embodiment, includes individual sequencers associated with thread slots of cores 2202. Usually a core 2202 is associated with a first ISA, which defines/specifies instructions executable on core 2202. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, decoders may, in one embodiment, include logic designed or adapted to recognize specific instructions, such as transactional instructions. As a result of the recognition by the decoders, the architecture of core 2202 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 2202, in one embodiment, recognize the same ISA (or a subset thereof). Alternatively, in a heterogeneous core environment, a decoder of one or more cores (e.g., core 2202B) may recognize a second ISA (either a subset of the first ISA or a distinct ISA).

In various embodiments, cores 2202 may also include one or more arithmetic logic units (ALUs), floating point units (FPUs), caches, instruction pipelines, interrupt handling hardware, registers, or other suitable hardware to facilitate the operations of the cores 2202.

Bus 2208 may represent any suitable interconnect coupled to CPU 2212. In one example, bus 2208 may couple CPU 2212 to another CPU of platform logic (e.g., via UPI). I/O blocks 2204 represents interfacing logic to couple I/O devices 2210 and 2215 to cores of CPU 2212. In various embodiments, an I/O block 2204 may include an I/O controller that is integrated onto the same package as cores 2202 or may simply include interfacing logic to couple to an I/O controller that is located off-chip. As one example, I/O blocks 2204 may include PCIe interfacing logic. Similarly, memory controller 2206 represents interfacing logic to couple memory 2214 to cores of CPU 2212. In various embodiments, memory controller 2206 is integrated onto the same package as cores 2202. In alternative embodiments, a memory controller could be located off chip.

As various examples, in the embodiment depicted, core 2202A may have a relatively high bandwidth and lower latency to devices coupled to bus 2208 (e.g., other CPUs 2212) and to NICs 2210, but a relatively low bandwidth and higher latency to memory 2214 or core 2202D. Core 2202B may have relatively high bandwidths and low latency to both NICs 2210 and PCIe solid state drive (SSD) 2215 and moderate bandwidths and latencies to devices coupled to bus 2208 and core 2202D. Core 2202C would have relatively high bandwidths and low latencies to memory 2214 and core 2202D. Finally, core 2202D would have a relatively high bandwidth and low latency to core 2202C, but relatively low bandwidths and high latencies to NICs 2210, core 2202A, and devices coupled to bus 2208.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stages, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, HDL, and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of a system on chip (SoC) and other hardware devices. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, such as reset, while an updated value potentially includes a low logical value, such as set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a processor; a memory, where the memory includes a shared memory region; an I/O interface; a network interface; and a cross-domain solutions (CDS) manager executable by the processor to: create a buffer in the shared memory region to allow writes by a first software module in a first domain and reads by a second software module in a second domain, where the reads are received from the second software module over a network connection facilitated by the network interface; and use the buffer to implement a memory-based communication channel between the first software module and the second software module, where the first domain is independent of the second domain.

Example 2 includes the subject matter of example 1, where the first software module is hosted on a first host device associated with the first domain and the second software module is hosted on a second host device associated with the second domain.

Example 3 includes the subject matter of example 2, where the first host device is coupled via the I/O interface.

Example 4 includes the subject matter of example 3, where a third host device is also coupled to the apparatus via the I/O interface.

Example 5 includes the subject matter of example 4, where the CDS manager is to implement another memory-based communication channel for access by the third host device in the shared memory region at least partially concurrent with the memory based communication channel.

Example 6 includes the subject matter of any one of examples 1-5, where the apparatus includes a first network processing device, and the second software module sends read requests for the buffer over a second network processing device coupled to the network interface.

Example 7 includes the subject matter of any one of examples 5-6, where the first network processing device is coupled to the second network processing device by a network communication link.

Example 8 includes the subject matter of example 6, where the network communication link is based on an Ethernet protocol.

Example 9 includes the subject matter of any one of examples 5-8, where the first network processing device is coupled to a third network processing device via the I/O interface.

Example 10 includes the subject matter of example 8, where a third domain is coupled to the third network processing device and the CDS manager is to create a second buffer at least partially concurrent with the buffer to facilitate a second memory-based communication channel between the first domain and the third domain.

Example 11 includes the subject matter of any one of examples 5-10, where the first network processing device is to forward reads by the first domain to another memory-based communication channel implemented in shared memory of the second network processing device.

Example 12 includes the subject matter of any one of examples 1-11, where the I/O interface includes one or more ports to support links according to one or more of a Peripheral Component Interconnect Express (PCIe)-, Compute Express Link (CXL)-, or NVLink-based protocol.

Example 13 includes the subject matter of any one of examples 1-12, where the buffer includes one of a store-and-forward buffer or a streaming buffer.

Example 14 includes the subject matter of any one of examples 1-13, where the first domain has a higher trust level than the second domain.

Example 15 includes the subject matter of any one of examples 1-14, where the buffer is created based on a buffer scheme, and the buffer scheme defines a configuration for the buffer.

Example 16 includes the subject matter of example 15, where the buffer scheme defines access rules for reads of the buffer by the second software module.

Example 17 includes the subject matter of any one of examples 15-16, where the buffer scheme defines at least one of a protocol or a datagram format for communication of data over the memory-based communication channel.

Example 18 includes the subject matter of any one of examples 1-17, where the CDS manager is to tear down the buffer following an end of a session involving the first software module and the second software module.

Example 19 is a method including: coupling a first network processing device to a second network processing device over a network interface; coupling the first network processing device to a third network processing device over an I/O interface; creating a buffer in a shared memory region of the first network processing device to implement a memory-based communication channel between a first software module in a first domain and a second software module in a second domain, where the first domain is independent of the second domain, the first domain is implemented on a first host device coupled to an interface of the first network processing device, and the second domain is implemented on a second host device coupled to one of the second network processing device or the third network processing device; receiving data from the first software module to be written to the buffer, where the data is received from the first host device over the interface coupling the first host device to the first network processing device; and facilitating an access to the data in the buffer by the second software module via one of the second network processing device or the third network processing device.

Example 20 includes the subject matter of example 19, where the first network processing device, the second network processing device, and the third processing device respectively include one of an infrastructure processing unit (IPU), a data processing unit (DPU), or a smartNIC device.

Example 21 includes the subject matter of any one of examples 19-20, further including enforcing a policy for the buffer to limit access to the buffer to the first software module and the second software module.

Example 22 includes the subject matter of any one of examples 19-21, further including closing the memory-based communication channel following conclusion of a session between the first software module and the second software module, and removing the buffer from the shared memory region based on closing the memory-based communication channel.

Example 23 includes the subject matter of any one of examples 19-22, where the buffer includes one of a store-and-forward buffer or a streaming buffer.

Example 24 includes the subject matter of any one of examples 19-23, where the first domain has a higher trust level than the second domain.

Example 25 includes the subject matter of any one of examples 19-24, where the buffer is created based on a buffer scheme, and the buffer scheme defines a configuration for the buffer.

Example 26 includes the subject matter of example 25, where the buffer scheme defines access rules for reads of the buffer by the second software module.

Example 27 includes the subject matter of any one of example 25-26, where the buffer scheme defines at least one of a protocol or a datagram format for communication of data over the memory-based communication channel.

Example 28 includes the subject matter of any one of examples 19-27, where the CDS manager is to tear down the buffer following an end of a session involving the first software module and the second software module.

Example 29 is a system including means to perform the method of any one of examples 19-28.

Example 30 is a system including: a first network processing device; and a second network processing device including: a processor; a memory, where the memory includes a shared memory region; an I/O interface; a network interface, where the first network processing device is coupled to the second network processing device by one of the I/O interface of the network interface; a cross-domain solutions (CDS) manager executable by the processor to: create a buffer in the shared memory region to allow writes by a first software module in a first domain and reads by a second software module in a second domain, where the reads are received from the second software module over the first network processing device; and use the buffer to implement a memory-based communication channel between the first software module and the second software module, where the first domain is independent of the second domain.

Example 31 includes the subject matter of example 30, further including: a first host device coupled to the second network processing device, where the first host device is to execute the first software module; and a second host device coupled to the first network processing device, where the second host device is to execute the second software module.

Example 32 includes the subject matter of example 31, further including a third host device coupled to the second network processing device, where the CDS manager is further executable to create a second buffer in the shared memory region to implement a second memory-based communication channel for communication between the first domain and a third domain associated with the third host device.

Example 33 includes the subject matter of any one of examples 30-32, further including a third network processing device, where the first network processing device is coupled to the second network processing device through a first port of the network interface, and the third network processing device is coupled to the second network processing device through a second port of the network interface.

Example 34 includes the subject matter of any one of examples 30-33, further including a third network processing device, where the first network processing device is coupled to the second network processing device through a port of the I/O interface, and the third network processing device is coupled to the second network processing device through a port of the network interface.

Example 35 includes the subject matter of any one of examples 30-34, where the first network processing device, the second network processing device, and the third processing device respectively include one of an infrastructure processing unit (IPU), data processing unit (DPU), or smartNIC device.

Example 36 includes the subject matter of any one of examples 30-35, where the first domain includes a first operating environment and the second domain includes a different, second operating environment.

Example 37 includes the subject matter of example 36, where the first operating environment includes one of a virtual machine or an operating system.

Example 38 includes the subject matter of any one of examples 30-37, where the network interface supports an Ethernet-based protocol.

Example 39 includes the subject matter of any one of examples 30-38, where the first network processing device is to forward reads by the first domain to another memory-based communication channel implemented in shared memory of the second network processing device.

Example 40 includes the subject matter of any one of examples 30-39, where the I/O interface includes one or more ports to support links according to one or more of a Peripheral Component Interconnect Express (PCIe)-, Compute Express Link (CXL)-, or NVLink-based protocol.

Example 41 includes the subject matter of any one of examples 30-40, where the buffer includes one of a store-and-forward buffer or a streaming buffer.

Example 42 includes the subject matter of any one of examples 30-41, where the first domain has a higher trust level than the second domain.

Example 43 includes the subject matter of any one of examples 30-42, where the buffer is created based on a buffer scheme, and the buffer scheme defines a configuration for the buffer.

Example 44 includes the subject matter of example 43, where the buffer scheme defines access rules for reads of the buffer by the second software module.

Example 45 includes the subject matter of any one of examples 43-44, where the buffer scheme defines at least one of a protocol or a datagram format for communication of data over the memory-based communication channel.

Example 46 includes the subject matter of any one of examples 30-45, where the CDS manager is to tear down the buffer following an end of a session involving the first software module and the second software module.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplary language does not necessarily refer to the same embodiment or the same example, but may refer to different and distinct embodiments, as well as potentially the same embodiment.

What is claimed is:

1. An apparatus comprising:
a processor;
a memory, wherein the memory comprises a shared memory region;
an I/O interface;
a network interface;
a cross-domain solutions (CDS) manager comprising instructions executable by the processor to:
create a buffer in the shared memory region to allow writes by a first software module in a first domain and reads by a second software module in a second domain, wherein the reads are received by the second software module over a network connection facilitated by the network interface; and
use the buffer to implement a memory-based communication channel between the first software module and the second software module, wherein the first domain is independent of the second domain.

2. The apparatus of claim 1, wherein the first software module is hosted on a first host device associated with the first domain and the second software module is hosted on a second host device associated with the second domain.

3. The apparatus of claim 2, wherein the I/O interface is to couple to the first host device.

4. The apparatus of claim 3, wherein the I/O interface is to also couple to a third host device.

5. The apparatus of claim 4, wherein the CDS manager further comprises instructions executable to implement another memory-based communication channel for access by the third host device in the shared memory region at least partially concurrent with the memory-based communication channel.

6. The apparatus of claim 1, wherein the apparatus comprises a first network processing device, and the second software module is to send read requests for the buffer over a second network processing device via the network interface.

7. The apparatus of claim 6, wherein the first network processing device is to couple to a third network processing device via the I/O interface.

8. The apparatus of claim 7, wherein a third domain is to couple to the third network processing device, and the CDS manager comprises instructions to create a second buffer in the shared memory region, wherein the second buffer is implemented at least partially concurrently in the shared memory region with the buffer to facilitate a second memory-based communication channel between the first domain and the third domain.

9. The apparatus of claim 6, wherein the first network processing device is to forward reads by the first domain to another memory-based communication channel implemented in shared memory of the second network processing device.

10. The apparatus of claim 1, wherein the network interface comprises one or more ports to support an Ethernet-based protocol, and the I/O interface comprises one or more ports to support links according to one or more of a Peripheral Component Interconnect Express (PCIe)-based, Compute Express Link (CXL)-based, or NVLink-based protocol.

11. The apparatus of claim 1, wherein the buffer comprises one of a store-and-forward buffer or a streaming buffer.

12. The apparatus of claim 1, wherein the first domain has a higher trust level than the second domain.

13. The apparatus of claim 1, wherein the buffer is created based on a buffer scheme, and the buffer scheme defines a configuration for the buffer.

14. The apparatus of claim 13, wherein the buffer scheme defines at least one of a protocol or a datagram format for communication of data over the memory-based communication channel.

15. A method comprising:
coupling a first network processing device to a second network processing device over a network interface;
coupling the first network processing device to a third network processing device over an I/O interface;
creating a buffer in a shared memory region of the first network processing device to implement a memory-based communication channel between a first software module in a first domain and a second software module in a second domain, wherein the first domain is independent of the second domain, the first domain is implemented on a first host device coupled to an interface of the first network processing device, and the second domain is implemented on a second host device coupled to one of the second network processing device or the third network processing device;
receiving data from the first software module to be written to the buffer, wherein the data is received from the first host device over the interface coupling the first host device to the first network processing device; and
facilitating an access to the data in the buffer by the second software module via one of the second network processing device or the third network processing device.

16. The method of claim 15, further comprising routing, from the first network processing device to the second network processing device, a request by the first domain to access another buffer implementing another memory-based communication channel, wherein the other buffer is implemented in memory of the second network processing device, and the other memory-based communication channel facilitates data transfers from the second domain to the first domain.

17. A system comprising:
a first network processing device; and
a second network processing device comprising:
a processor;
a memory, wherein the memory comprises a shared memory region;
an I/O interface;
a network interface, wherein the first network processing device is coupled to the second network processing device by one of the I/O interface or the network interface;
a cross-domain solutions (CDS) manager comprising instructions executable by the processor to:
create a buffer in the shared memory region to allow writes by a first software module in a first domain and reads by a second software module in a second domain, wherein the reads are received by the second software module over the first network processing device; and
use the buffer to implement a memory-based communication channel between the first software module and the second software module, wherein the first domain is independent of the second domain.

18. The system of claim 17, wherein the first network processing device and the second network processing device respectively comprise one of an infrastructure processing unit (IPU), data processing unit (DPU), or smartNIC device.

19. The system of claim 17, wherein the first domain comprises a first operating environment and the second domain comprises a different, second operating environment.

20. The system of claim 17, further comprising:
a first host device coupled to the second network processing device, wherein the first host device is to execute the first software module; and
a second host device coupled to the first network processing device, wherein the second host device is to execute the second software module.
